(19) United States
(12) Patent Application Publication
(10) Pub. No.: US 2010/0166289 A1
(43) Pub. Date: Jul. 1, 2010

(54) FEATURE-QUANTITY EXTRACTING METHOD, DESIGNED-CIRCUIT-PATTERN VERIFYING METHOD, AND COMPUTER PROGRAM PRODUCT

(76) Inventors: Masaki SATAKE, Kanagawa (JP); Masafumi Asano, Kanagawa (JP); Satoshi Tanaka, Kanagawa (JP); Taiga Uno, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/646,677

(22) Filed: Dec. 23, 2009

(30) Foreign Application Priority Data
Dec. 27, 2008 (JP) 2008-335484

(51) Int. Cl. G06K 9/46; G06T 7/00

(52) U.S. Cl. 382/144; 382/195

(57) ABSTRACT

Feature-quantity extraction parameters used by feature-quantity extraction functions for calculating feature quantities used as explanatory variables of a resist model for predicting a resist image are set. The feature-quantity extraction functions, for which the feature-quantity extraction parameters are set, are caused to act on optical images of a pattern of a photomask to calculate feature quantities from the optical images.

### CROSS-REFERENCE TO RELATED APPLICATIONS

This application is based upon and claims the benefit of priority from the prior Japanese Patent Application No. 2008-335484, filed on Dec. 27, 2008; the entire contents of which are incorporated herein by reference.

### BACKGROUND OF THE INVENTION

1. Field of the Invention

The present invention relates to a feature-quantity extracting method, a designed-circuit-pattern verifying method, and a computer program product.

2. Description of the Related Art

At present, it is a general practice to execute optical proximity correction (OPC) on a photomask used in photolithography. The OPC is a technology for adjusting a layout of a photomask in advance to form a desired pattern on a wafer. To execute the OPC, it is indispensable to perform simulation for accurately predicting a finish of a pattern on a wafer from a mask layout drawing of a circuit pattern.

The simulation for execution of the OPC requires a simulation model called resist model for calculating a resist image from optical simulation images (hereinafter simply referred to as “optical images”) of a mask pattern projected on a wafer taking into account properties of a resist applied on the wafer. When the resist model is created, a plurality of test patterns of various shapes selected in advance are actually exposed to light and a resist dimension is experimentally measured in advance. The simulation is performed under conditions same as exposure conditions and calibration parameters are optimized to reproduce an experimental result, whereby the resist model is created.

In work for measuring a resist dimension as a basis for resist model creation, selection of test patterns to be used is important. When features of an actual circuit pattern that should be predicted (hereinafter simply referred to as “circuit pattern”) and features of a test pattern used for resist model creation are substantially different from each other, it is difficult to create an effective resist model. It is desirable that a plurality of kinds of test patterns are selected and features of the selected kinds of test patterns include all features of a pattern that should be predicted. Recently, feature quantities representing features of optical images obtained by optical calculation for a circuit pattern are extracted from the optical images and test patterns are selected to cover a distribution of the feature quantities of the circuit pattern.

In recent years, microminiaturization of semiconductor integrated circuits is advanced and circuit pattern density is markedly increased. Therefore, in a 45 nm node or beyond, a method called Dense OPC for once calculating resist image intensity on two-dimensional grids and calculating resist image intensity in sections among the grids according to interpolation is effective for an increase in simulation speed (see, for example, Proc. SPIE Vol. 6154 01-1). As a resist image description system of a resist model for describing a two-dimensional resist image, for example, there is a constant threshold model (CTM). With the CTM, feature quantities are extracted from optical images, the extracted feature quantities are multiplied by calibration parameters, and the feature quantities multiplied by the calibration parameters are added to the original optical images to describe a resist image.

When a resist image description system for using feature quantities as explanatory variables such as the CTM is adopted, it is desirable to use test patterns selected based on types of feature quantities same as types of feature quantities used in the CTM. However, when the types of feature quantities used in the CTM are calculated, feature-quantity extraction parameters are used. The feature-quantity extraction parameters require optimization based on a test pattern measurement result. Therefore, feature quantities cannot be extracted at a stage of test pattern selection before the optimization. If a resist model is created by using a model pattern selected by using types of feature quantities different from specific feature quantities used in the CTM, it is likely that the created resist model of the CTM does not entirely cover features of a circuit pattern. As a result, prediction accuracy for a resist image of the circuit pattern is not guaranteed.

### BRIEF SUMMARY OF THE INVENTION

A feature-quantity extracting method according to an embodiment of the present invention comprises: setting feature-quantity extraction parameters used by feature-quantity extraction functions for calculating feature quantities used as explanatory variables of a resist model for predicting a resist image; and causing the feature-quantity extraction functions, for which the feature-quantity extraction parameters are set, to act on optical images of a pattern of a photomask and calculating feature quantities from the optical images.

A designed-circuit pattern verifying method according to an embodiment of the present invention comprises: setting feature-quantity extraction parameters used by feature-quantity extraction functions for calculating feature quantities used as explanatory variables of a resist model for predicting a resist image; causing the feature-quantity extraction functions, for which the feature-quantity extraction parameters are set, to act on optical images of a circuit pattern created by a designer and calculating feature quantities at a plurality of points of the circuit pattern from the optical images; comparing a distribution of the calculated feature quantities and a distribution of feature quantities of test patterns and extracting a point of the circuit pattern deviating from a range of the feature quantity distribution of the test patterns; and displaying the extracted point of the circuit pattern on a display device.

A computer program product according to an embodiment of the present invention executable by a computer, the computer program product causes the computer to execute: setting feature-quantity extraction parameters used by feature-quantity extraction functions for calculating feature quantities used as explanatory variables of a resist model for predicting a resist image; and causing the feature-quantity extraction functions, for which the feature-quantity extraction parameters are set, to act on optical images of a pattern of a photomask and calculating feature quantities from the optical images.

### BRIEF DESCRIPTION OF THE DRAWINGS

FIG. 1 is a flowchart for explaining a basic procedure for creating a resist model;

FIG. 2 is a block diagram for explaining the configuration of a feature-quantity extracting apparatus according to a first embodiment of the present invention;

FIG. 3 is a flowchart for explaining the operation of the feature-quantity extracting apparatus according to the first embodiment;

FIGS. 4A to 4C are graphs on which calculated feature quantities are plotted;

FIG. 5 is a diagram for explaining the configuration of a usual computer;

FIG. 6 is a block diagram of the configuration of a test-pattern selecting apparatus according to a second embodiment of the present invention;

FIGS. 7A to 7I are diagrams for explaining examples of kinds of test patterns;

FIGS. 8A to 8D are diagrams for explaining examples of kinds of test patterns;

FIG. 9 is a flowchart for explaining the operation of the test-pattern selecting apparatus according to the second embodiment;

FIG. 10 is a graph on which feature quantities of test patterns are plotted;

FIG. 11 is a block diagram for explaining the configuration of a resist-model creating apparatus according to a third embodiment of the present invention;

FIG. 12 is a diagram for explaining an example of a layout on a mask of test patterns;

FIG. 13 is a diagram for explaining a resist pattern;

FIG. 14 is a graph on which image intensity in a longitudinal direction of optical images is plotted;

FIG. 15 is a flowchart for explaining the operation of the resist-model creating apparatus according to the third embodiment;

FIG. 16 is a diagram for explaining Imax and slope;

FIG. 17 is a diagram for explaining an example of a circuit pattern;

FIG. 18 is a diagram for explaining a feature quantity distribution of the circuit pattern;

FIG. 19 is a diagram for explaining the feature quantity distribution of the circuit pattern and a feature quantity distribution of test patterns to be created;

FIGS. 20A and 20B are diagrams for explaining an example of a layout on a photomask of test patterns and a resist pattern;

FIG. 21 is a graph of a relation between a first feature quantity and a residual;

FIG. 22 is a block diagram for explaining the configuration of a resist-model creating apparatus according to a fourth embodiment of the present invention;

FIG. 23 is a flowchart for explaining the operation of the resist-model creating apparatus according to the fourth embodiment;

FIG. 24 is a conceptual diagram for explaining a state in which a relation between a first feature quantity and a residual linearly regresses on a high-dimensional space;

FIG. 25 is a diagram for explaining a comparison result obtained by comparing differences between predicted dimensions and actual dimensions of a resist image calculated by a nonlinear model (a method according to the present invention) and a linear model (the method in the past);

FIG. 26 is a diagram for explaining a comparison result obtained by comparing fluctuations in the differences between the predicted dimensions and the actual dimensions of the resist image calculated by the nonlinear model (the method according to the present invention) and the linear model (the method in the past);

FIG. 27 is a block diagram for explaining the configuration of a designed-circuit-pattern verifying apparatus according to a fifth embodiment of the present invention;

FIG. 28 is a flowchart for explaining the operation of the designed-circuit-pattern verifying apparatus according to the fifth embodiment;

FIG. 29A is a mask layout drawing of a designed circuit pattern;

FIG. 29B is a graph on which feature quantities of the layout drawing and feature quantities of test patterns are plotted;

FIG. 30A is a mask layout drawing of a corrected circuit pattern; and

FIG. 30B is a graph on which feature quantities of the layout drawing and feature quantities of test patterns are plotted.

### DETAILED DESCRIPTION OF THE INVENTION

Exemplary embodiments of a feature-quantity extracting method, a designed-circuit-pattern verifying method, and a computer program product according to the present invention will be explained below in detail with reference to the accompanying drawings. The present invention is not limited to the following embodiments.

Lithography simulation models include a mask model, an optical model, and a resist model. In photolithography, exposure light is irradiated on a photomask and light transmitted through the photomask is irradiated on a resist on a wafer via a projection optical system. The mask model is a model for calculating, from a layout drawing of a mask pattern, how the light transmitted through the photomask changes. Optical images corresponding to a mask pattern formed on the photomask are projected on the resist formed on the wafer. The optical model is a model for calculating a light intensity distribution of the optical images on the resist. A latent image is formed on the resist according to the light intensity distribution of the optical images on the resist. A resist pattern corresponding to the latent image is obtained by performing development processing. The resist model is a model for calculating a resist pattern (a resist image) from the light intensity distribution of the optical images. A dimension of the resist pattern (a resist dimension) can be predicted from a mask layout drawing by combining the mask model, the optical model, and the resist model.

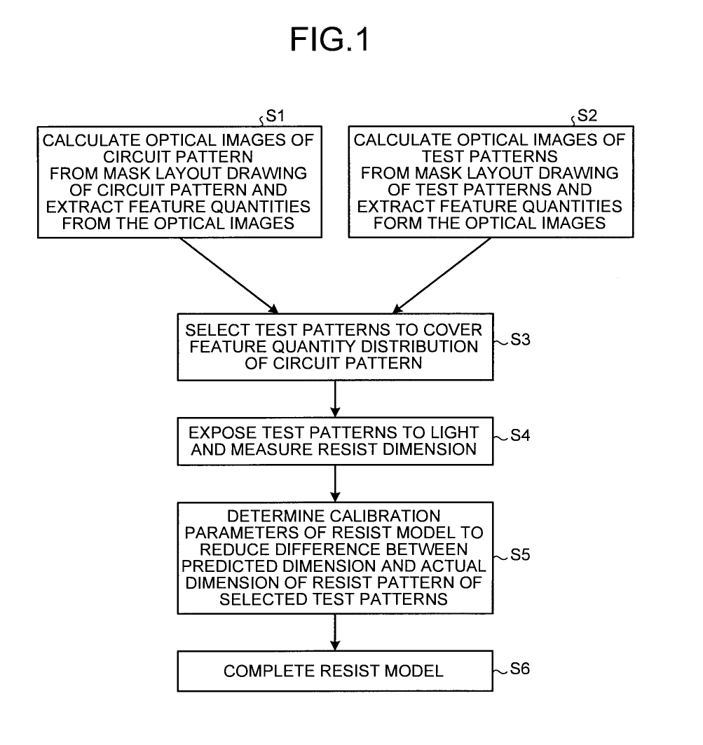

FIG. 1 is a flowchart for explaining a basic procedure for creating a resist model.

The resist model is created by executing optimization work to reduce a difference between an actual value of a resist dimension and a predicted value by simulation (a residual) as much as possible. As a mask pattern for measuring the actual value, rather than an actual circuit pattern itself having a pattern of an extremely complicated shape, a pattern of a simple shape having features similar to those of a circuit pattern is used to improve measurement accuracy for the actual value used for the optimization work. Therefore, first, work for selecting several test patterns is executed to cover features of a circuit pattern that should be predicted from a prepared large number of test patterns of simple shapes.

In FIG. 1, simulation by a combination of the mask model and the optical model is applied to a mask layout drawing of an actual circuit pattern to calculate optical simulation images (optical images) and feature quantities are extracted from the optical images (step S1). Feature quantities are also extracted from a mask layout drawing of various test patterns prepared in advance according to the same method (step S2).

The feature quantities are values representing features of objects (optical images). Various types of feature quantities can be defined according to what types of features the feature quantities represent. For example, a tilt (Slope) as a tilt of the intensity of the optical images, a maximum of the intensity of the optical images (Imax), and a minimum of the intensity of the optical images (Imin) can be defined as the feature quantities.

The test patterns prepared in advance include various kinds of test patterns such as isoLine as an independent line, isoSpace as an independent space, a Pitch type in which a large number of lines are arranged in parallel spaces away from one another, 2-Line in which two lines are arranged in parallel, 3-Line in which three lines are arranged in parallel, and isoLE (Line End) in which two lines are arranged on the same straight line slightly away from each other. For the respective kinds of the test patterns, there are a large number of patterns having different dimensions of lines and spaces.

In the following explanation, calculating optical images from a mask layout drawing of a mask pattern (a circuit pattern or a test pattern) and extracting feature quantities from the optical images may be simply represented as extracting feature quantities from the mask pattern. Feature quantities extracted from optical images of a mask pattern may be simply represented as feature quantities of the mask pattern.

At step S1, when the feature quantities are extracted from the circuit pattern, feature quantities at a plurality of points of the circuit pattern are extracted based on rules set in advance. For example, it is also possible to virtually arrange two-dimensional grids in the mask layout drawing of the circuit pattern and extract feature quantities at a plurality of points where the grids and the circuit pattern rendered on the mask layout drawing cross. At step S2, when feature quantities are calculated from the test patterns, feature quantities at points determined in advance for each of the test patterns are extracted. For example, in the case of a test pattern of an independent line type, an edge section is set in advance in the center of a line as an extraction point. In the following explanation, extracting feature quantities from a plurality of points of the circuit pattern on the mask layout drawing may be simply represented as extracting feature quantities from the circuit pattern. A distribution of a plurality of feature quantities extracted from a plurality of points of the circuit pattern on the mask layout drawing may be simply represented as a distribution of feature quantities of the circuit pattern or a feature quantity distribution of the circuit pattern.

At the following steps S1 and S2, a distribution of the feature quantities of the circuit pattern calculated at step S1 and a distribution of the feature quantities of the large number of test patterns calculated at step S2 are compared for each of types of the feature quantities and test patterns are selected to sufficiently cover the distribution of the feature quantities of the circuit pattern (step S3). As a method of selecting test patterns to cover the feature quantities of the points of the circuit pattern, there are various methods. For example, as described in a document “Proc. of SPIE Vol. 6520 652048-5”, there is a selection method for plotting feature quantities of a circuit pattern and test patterns on a graph having various feature quantities as different coordinate axes (hereinafter, “feature space”), dividing the coordinate axes with grids at fixed intervals and, paying attention to respective small regions in a minimum unit divided by the grids, executing, in the respective small regions, work for, in the small region where the feature quantities of any one of the points of the circuit pattern are plotted, leaving one test pattern and deleting the other test patterns in the same small region, in the small region where no feature quantities of the points of the circuit pattern are plotted, deleting all the test patterns in the same small region, and selecting the remaining test patterns.

The work shifts to work for creating a resist model based on the selected test patterns. First, the test patterns selected at step S3 are actually exposed to light and a resist dimension of an obtained resist pattern is measured by using a critical dimension scanning electron microscope (CD-SEM) (step S4). Calibration parameters included in a resist model are optimized to reduce a difference (a residual) between a resist dimension (a predicted dimension) obtained by the resist model and the resist dimension (an actual dimension) measured at step S4 (step S5). The calibration parameters are optimized to sufficiently reduce the residual and the resist model is completed (step S6).

As one of resist image description systems that can describe a two-dimensional resist image, there is CTM. With the CTM, when a Gaussian function concerning x of a standard deviation σx is represented as G(σx, x) and optical images are represented as I, a resist image R is described as follows:

R=I+A*G(σ1,I)+B*G(σ2,f1(I))+C*G(σ3,f2(I)) Formula 1

where, f1 and f2 are the following functions:

f1(I)=if(I>b0)I−b0, else 0 Formula 2

f2(I)=if(<b1)bI−I, else 0 Formula 3

G(σ1, I), G(σ2, f1(I)), and G(σ3, f2(I)) are respectively a feature-quantity extraction function (a first feature-quantity extraction function) for extracting a feature quantity (a first feature quantity) concerning fluctuation of the optical images, a feature-quantity extraction function (a second feature-quantity extraction function) for extracting a feature quantity (a second feature quantity) concerning a diffusion behavior of acid, and a feature-quantity extraction function (a third feature-quantity extraction function) for extracting a feature quantity (a third feature quantity) concerning a diffusion behavior of a base. As indicated by Formulas 1 to 3, the resist image R is described as a value obtained by adding up the first to third feature quantities respectively obtained by multiplying the optical images I with calibration parameters A, B, and C. In other words, a resist model by the CTM is a linear model with the first to third feature quantities set as explanatory variables.

To allow this model to hold in a range of values of the explanatory variables (i.e., the first to third feature quantities) taken by a circuit pattern that should be predicted, it is necessary to select test patterns to completely include (cover) a range of the first to third feature quantities that could be taken by the circuit pattern. To select test patterns to strictly completely include the range of the first to third feature quantities of the circuit pattern, it is desirable to use the first to third feature quantities used in the CTM during test pattern selection, i.e., in the process of steps S1 to S3.

However, σ1, σ2, σ3, b0, and b1 (all of which are referred to as feature-quantity extraction parameters) used for calculating the first to third feature quantities are optimized together with A, B, and C at step S5. Therefore, values of the parameters are not decided at the stage of steps S1 to S3. In other words, when a resist model is created by using the CTM, feature quantities cannot be calculated by using the first to third feature quantities during the processing at steps S1 to S3. Therefore, according to this embodiment, the first to third feature quantities can be extracted even before the optimization of the resist model by setting and using values for σ1, σ2, σ3, b0, and b1.

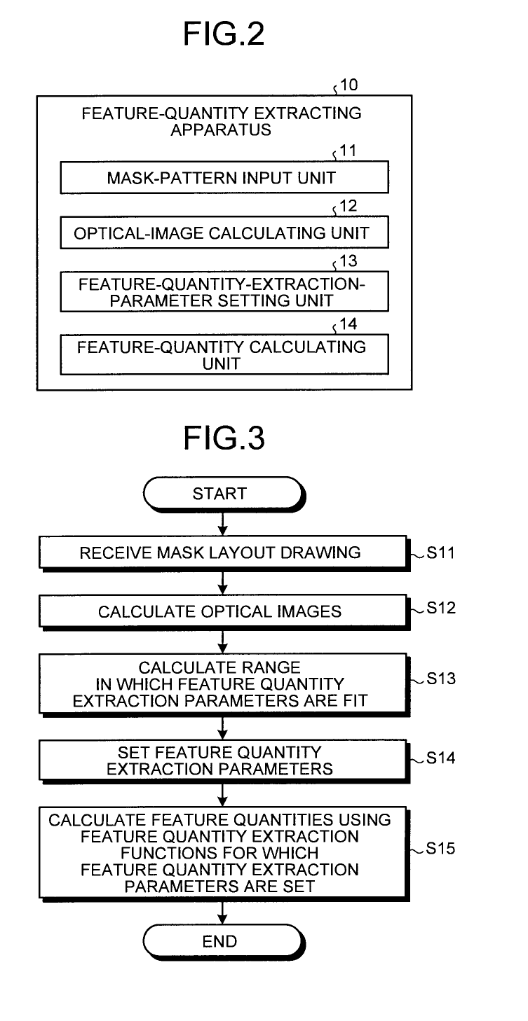

FIG. 2 is a block diagram for explaining the configuration of a feature-quantity extracting apparatus according to a first embodiment of the present invention. As shown in FIG. 2, a feature-quantity extracting apparatus 10 includes a mask-pattern input unit 11 that receives the input of a mask layout drawing of a mask pattern from which feature quantities are extracted, an optical-image calculating unit 12 that executes simulation with a mask model and an optical model applied to the received mask pattern of the mask layout drawing and calculates optical images, a feature-quantity-extraction-parameter setting unit 13 that sets feature-quantity extraction parameters, and a feature-quantity calculating unit 14 that causes a feature-quantity extraction function, to which the feature-quantity extraction parameters set by the feature-quantity-extraction-parameter setting unit 13 is applied, to act on the optical images calculated by the optical-image calculating unit 12 and calculates feature quantities.

FIG. 3 is a flowchart for explaining the operation of the feature-quantity extracting apparatus 10 according to the first embodiment.

In FIG. 3, first, the mask-pattern input unit 11 receives a mask pattern layout drawing of a mask pattern (step S11). At step S1, the mask pattern indicates an actual circuit pattern. At step S2, the mask pattern indicates a test pattern before selection prepared in advance.

Subsequently, the optical-image calculating unit 12 calculates optical images from the received mask layout drawing of the mask pattern (step S12). Specifically, for example, the optical-image calculating unit 12 calculates a mask transmission function from the mask layout drawing and calculates optical images projected on a resist based on the calculated mask transmission function and set conditions for an illumination system and an optical system of an exposure apparatus.

The feature-quantity-extraction-parameter setting unit 13 acquires several feature-quantity extraction parameters of resist models in the past and calculates a range of the feature-quantity extraction parameters of the resist models in the past, i.e., a range of fluctuation in the feature-quantity extraction parameters (step S13). The feature-quantity-extraction-parameter setting unit 13 extracts a representative value of the feature-quantity extraction parameters from the calculated range and sets the representative value as a feature-quantity extraction parameter before optimization (step S14). The feature-quantity calculating unit 14 calculates the first to third feature quantities for the optical images calculated at step S12 using first to third feature-quantity extraction functions for which the feature-quantity extraction parameter set at step S14 is set (step S15). When a plurality of values are set for one type of feature-quantity extraction parameter by the feature-quantity-extraction-parameter setting unit 13, a plurality of feature quantities are calculated for one type of feature quantity based on the feature-quantity extraction functions for which the set respective values are set.

For example, at step S13, the feature-quantity-extraction-parameter setting unit 13 checks values of σ1, σ2, σ3, b0, and b1 from eight actual resist models in total in several generations and layers in the past and finds that the values are respectively in ranges 10 nm<=σ1<=40 nm, 120 nm<=σ2<=200 nm, 140 nm<=σ3<=200 nm, 0.12<=b0<=0.16, and 0.07<=b1<=0.11. At step S14, the feature-quantity-extraction-parameter setting unit 13 sets various feature-quantity extraction parameters at an interval of fixed width in such a manner as σ1=10 nm, 20 nm, 30 nm, and 40 nm, σ2=100 nm, 150 nm, and 200 nm, σ3=100 nm, 150 nm, and 200 nm, b0=0.1, 0.15, and 0.2, and b1=0.05, 0.1, and 0.15.

The first to third feature quantities are independent from one another. There are four kinds of values of σ1, 3×3 kinds of values of combinations of σ2 and b0, and 3×3 kinds of values of combinations of σ3 and b1. Therefore, at step S15, the feature-quantity calculating unit 14 calculates four kinds of values, nine kinds of values, and nine kinds of values for the first to third feature quantities, respectively.

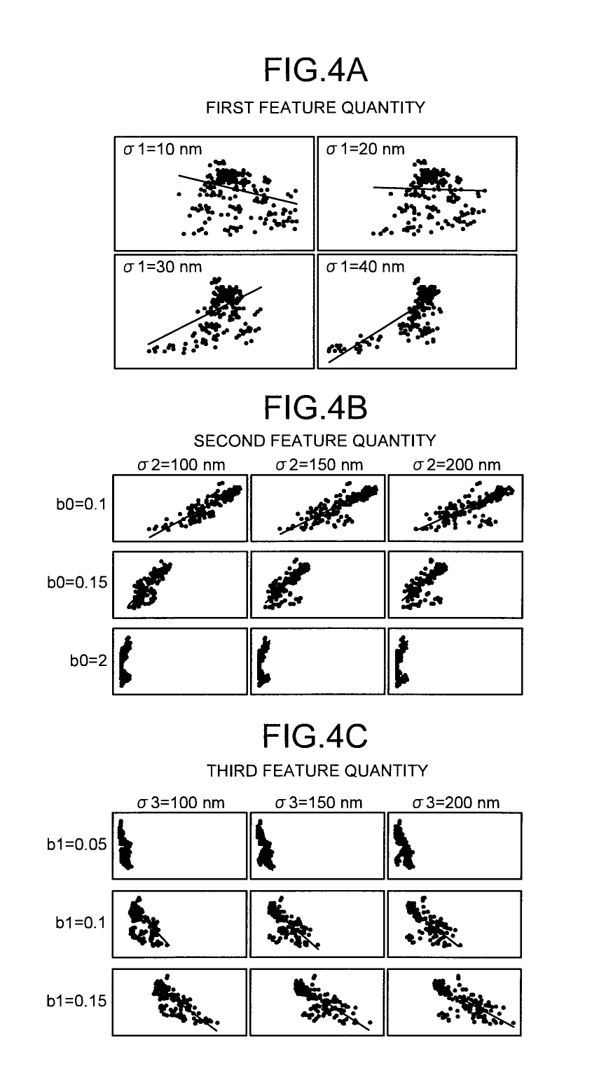

A graph on which feature quantities calculated by the feature-quantity calculating unit 14 from optical images of a certain circuit pattern using the example of the values of σ1, σ2, σ3, b0, and b1 are plotted with slope as the ordinate is shown in FIGS. 4A to 4C. FIGS. 4A, 4B, and 4C are graphs concerning the first, second, and third feature quantities, respectively. Four kinds of feature quantities, nine kinds of feature quantities, and nine kinds of feature quantities are respectively plotted in the figures based on variations of feature-quantity extraction parameters. As shown in the figures, even when feature quantities are the same kind of feature quantities, distributions of the feature quantities are slightly different if the feature-quantity extraction parameters are different. When test patterns are selected based on the feature quantities calculated by the feature-quantity extracting apparatus 10 at step S3, it is desirable to select test patterns to cover all distributions of the feature quantities shown in all the graphs shown in FIGS. 4A to 4C. When test patterns are selected for all the kinds of feature quantities to cover the distributions of the feature quantities of all the feature-quantity extraction parameters in this way, it is highly likely that an effective resist model that can be highly accurately predicted in a range of feature quantities taken by the circuit pattern as long as values of the feature-quantity extraction parameters after being optimized based on the selected test patterns are within the range calculated at step S13.

When a large number of values are set for one type of feature-quantity extraction parameters at an interval of small width from the range in which the feature-quantity extraction parameters are included, a resist model that can be highly accurately predicted can be more surely obtained than a resist model obtained when the number of values is small. However, labor and time at step S3 increase according to an increase in the number of values. Therefore, it is desirable to set values of the feature-quantity extraction parameters taking into account certainty of prediction accuracy and labor and time at step S3.

In the example of steps S13 and S14, values are set based on the range of fluctuation in the feature-quantity extraction parameters used in the resist models in the past. However, it is also possible that a user of the feature-quantity extracting apparatus 10 inputs a range of desired values of the feature-quantity extraction parameters and the feature-quantity-extraction-parameter setting unit 13 sets values of the feature-quantity extraction parameters from the input range. It is also possible that the user directly inputs desired values of the feature-quantity extraction parameters and the feature-quantity-extraction-parameter setting unit 13 sets the input values as the feature-quantity extraction parameters.

In the above explanation, the first to third feature quantities are set as the explanatory variables in the resist image description system by the CTM. However, in the CTM, types of feature quantities used as the explanatory variables are not limited to the first to third feature quantities and can be increased or decreased. When the types of feature quantities are increased, for example, slope can be added.

A feature-quantity extracting method according to the first embodiment can be applied in extracting feature quantities used in not only the CTM but also any resist image description system as long as at least one type of feature quantities that need to be extracted by using feature-quantity extraction functions for which feature-quantity extraction parameters are set.

In the above explanation, feature quantities are extracted from the optical images to predict a resist pattern. However, the feature-quantity extracting method according to the first embodiment can be applied in any case as long as, to create a model for predicting a second pattern using feature quantities extracted from a first pattern as explanatory variables, feature quantities are extracted from the first pattern by using feature-quantity extraction functions for which feature-quantity extraction parameters are set. For example, feature quantities can be extracted by applying the first embodiment when, to create, with feature quantities of a layout drawing of a mask pattern, optical images, or a resist image (a first pattern) set as explanatory variables, an etching model for predicting a pattern (a second pattern), which is formed in a processed layer by etching, using a resist pattern as a mask, feature quantities are extracted from the layout drawing of the mask pattern, the optical images, or the resist image by using the feature-quantity extraction functions for which the feature-quantity extraction parameters are set. Further, feature quantities can be extracted by applying the first embodiment when, to create a resist model for predicting a pattern (a second pattern) formed on a resist with feature quantities of a pattern (a first pattern) of a template set as explanatory variables in nano-imprinting for forming a pattern on the resist using the template, feature quantities are extracted from the pattern of the template by using the feature-quantity extraction functions for which the feature-quantity extraction parameters are set.

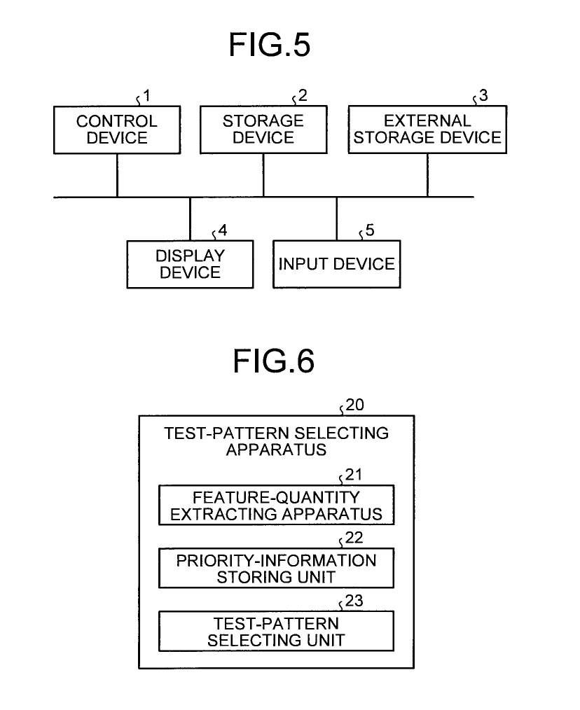

The feature-quantity extracting apparatus 10 according to the first embodiment can be realized by executing a computer program in a usual computer including a control device 1, a storage device 2, an external storage device 3, a display device 4, and an input device 5 shown in FIG. 5.

The control device 1 is, for example, a central processing unit (CPU). The control device 1 executes a feature-quantity extracting program as a program for extracting feature quantities. The display device 4 is a display device such as a liquid crystal monitor and displays, based on an instruction from the control device 1, output information for a user such as an operation screen. The input device 5 includes a mouse and a keyboard and receives the input of operation of the feature-quantity extracting apparatus 10 from the user. Operation information input to the input device 5 is sent to the control device 1. The storage device 2 is a memory area such as a read only memory (ROM) or a random access memory (RAM). The external storage device 3 is a hard disk drive (HDD), a compact disk (CD) drive, or the like.

The feature-quantity extracting program is stored in the ROM and loaded to the RAM. The control device 1 executes the feature-quantity extracting program loaded in the RAM. Specifically, in the feature-quantity extracting apparatus 10, the control device 1 reads out the feature-quantity extracting program from the ROM and expands the feature-quantity extracting program in a program storage area in the RAM to execute various kinds of processing according to instruction input from the input device 5 by the user. A mask layout drawing is input from the external storage device 3 or the like. The control device 1 executes the various kinds of processing based on the mask layout drawing input from the external storage device 3 or the like. The control device 1 temporarily stores data such as optical images and feature-quantity extraction parameters calculated in the various kinds of processing in a data storage area formed in the RAM. The control device 1 outputs calculated feature quantities to the program storage area in the RAM, the external storage device 3, or the like. The control device 1 can display the calculated feature quantities on the display device 4. The feature-quantity extracting program can be stored in the external storage device 3 instead of the ROM. The feature-quantity extracting program has a module configuration including the respective components (the mask-pattern input unit 11, the optical-image calculating unit 12, the feature-quantity-extraction-parameter setting unit 13, and the feature-quantity calculating unit 14). The control device 1 (the CPU) reads out the feature-quantity extracting program from the storage medium and executes the feature-quantity extracting program based on operation by the user via the input device 5. The respective modules are loaded onto the RAM by the execution. The mask-pattern input unit 11, the optical-image calculating unit 12, the feature-quantity-extraction-parameter setting unit 13, and the feature-quantity calculating unit 14 are generated on the main storage device.

The feature-quantity extracting program executed by the feature-quantity extracting apparatus 10 according to the first embodiment can be recorded in a computer-readable recording medium such as a compact disk-read only memory (CD-ROM), a flexible disk (FD), a compact disk-recordable (CD-R), or a digital versatile disk (DVD) as a file of an installable format or an executable format and provided.

The feature-quantity extracting program executed by the feature-quantity extracting apparatus 10 according to the first embodiment can be stored on a computer connected to a network such as the Internet and downloaded through the network to thereby be provided. The feature-quantity extracting program executed by the feature-quantity extracting apparatus 10 according to the first embodiment can be provided or distributed through the network such as the Internet.

The feature-quantity extracting program executed by the feature-quantity extracting apparatus 10 according to the first embodiment can be incorporated in the ROM or the like in advance and provided.

As explained above, according to the first embodiment, feature-quantity extraction parameters are set and feature quantities are extracted from optical images by using feature-quantity extraction functions for which the set feature-quantity extraction parameters are set. Therefore, it is possible to extract feature quantities even before the feature-quantity extraction parameters are optimized.

A second embodiment of the present invention is explained below. As explained above, a resist model is created to reduce a difference between an actual dimension of a resist pattern transferred from selected test patterns and created and a predicted dimension of a resist image by the resist model (step S5 in FIG. 1). Therefore, even if test patterns used for resist model creation is accurately selected by the application of the first embodiment or the like, creation of a highly accurate resist model cannot be expected if measurement accuracy for the actual dimension of the resist pattern of the selected test patterns is low.

On the other hand, test patterns are selected to cover feature quantities of a circuit pattern (step S3 in FIG. 1). When there are a plurality of test patterns having similar feature quantities, to efficiently perform optimization with reduced calculation cost, one or a small number of test patterns are left and the other test patterns are deleted from selection candidates. Among the test patterns prepared in advance, there are test patterns with which it is difficult to highly accurately measure a dimension of a resist pattern and test patterns in which the number of measurement sections is small and a statistic error of an actual dimension is large. However, at step S3, test patterns are selected without taking into account whether the test patterns are test patterns with which a dimension of a resist pattern can be accurately measured. Therefore, prediction accuracy for a resist model created by using the selected test patterns is not guaranteed.

Therefore, according to the second embodiment, when test patterns used for resist model creation are selected, test patterns having features with which a resist dimension can be more highly accurately measured are preferentially selected. FIG. 6 is a block diagram showing the configuration of a test-pattern selecting apparatus according to the second embodiment.

As shown in the figure, a test-pattern selecting apparatus 20 includes a feature-quantity extracting apparatus 21 that calculates optical images from a mask layout drawing of a large number of test patterns prepared in advance and a circuit pattern and extracts feature quantities from the calculated optical images, respectively, a priority-information storing unit 22 having stored therein priority information in which priority set for each of the test patterns according to measurement accuracy for a resist dimension is described, and a test-pattern selecting unit 23 that selects test patterns for resist model creation based on the feature quantities extracted by the feature-quantity extracting apparatus 21 and the priority information stored by the priority-information storing unit 22. The feature-quantity extracting apparatus 21 can be the same as the feature-quantity extracting apparatus 10 explained in the first embodiment.

The priority set for each of the test patterns described in the priority information is explained below.

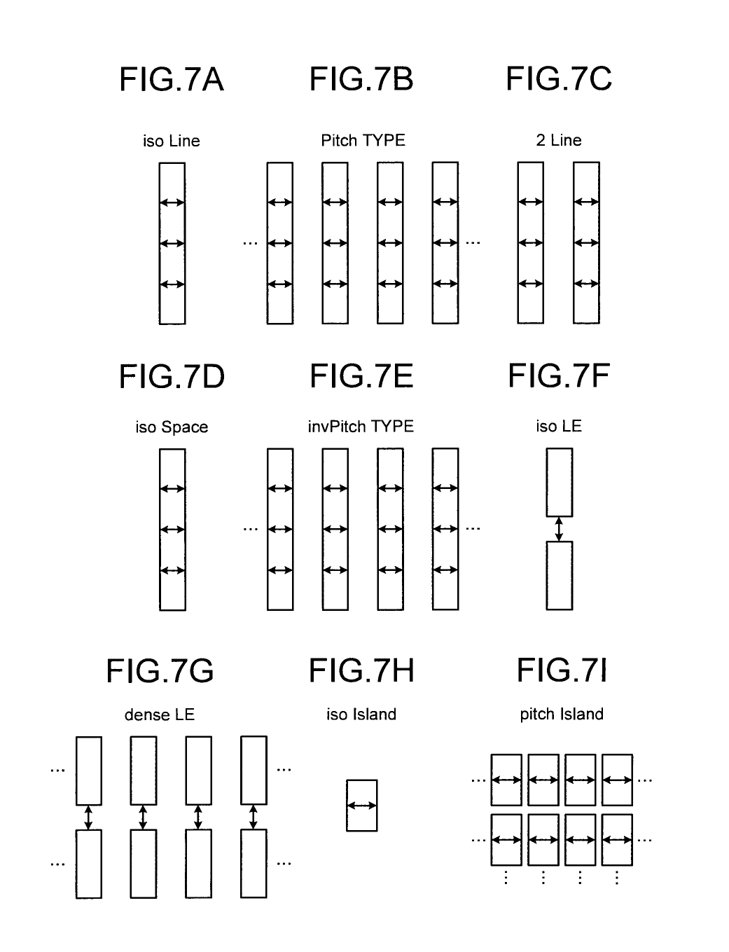

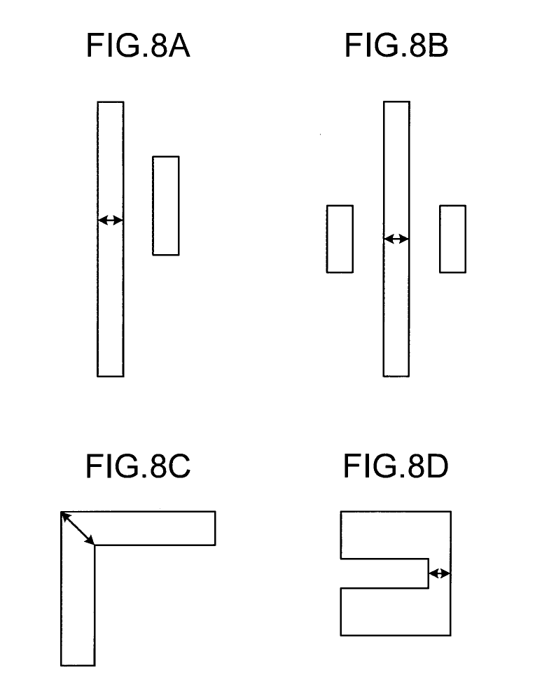

FIGS. 7A to 7I and FIGS. 8A to 8D are diagrams for explaining examples of test patterns. A test pattern shown in FIG. 7A is called isoLine. A test pattern shown in FIG. 7B is called Pitch type. A test pattern shown in FIG. 7C is called 2 Line. A test pattern shown in FIG. 7D is called isoSpace. A test pattern shown in FIG. 7E is called invPitch type. A test pattern shown in FIG. 7F is called isoLE L(Line End). A test pattern shown in FIG. 7G is called denseLE. A test pattern shown in FIG. 7H is called isoIsland. A test pattern shown in FIG. 7I is called pitchIsland. Rectangular sections of isoSpace shown in FIG. 7D and the invPitch type shown in FIG. 7E indicate light blocking sections. Rectangular sections of the test patterns of the other types indicate light transmitting sections.

Arrows in the figures indicate sections equivalent to sections where a resist dimension is measured in a resist image transferred onto a wafer. As shown in the figures, the test patterns shown in FIGS. 7A to 7E are formed in a shape having an aspect ratio (long side/short side) sufficiently larger than 1. The line width in the short side direction is used as a resist dimension. Therefore, a large number of measurement sections can be set in the long side direction of the rectangular pattern. In general, measurement accuracy is represented by 1/Sqrt (the number of measurement sections). For example, a test pattern including ten measurement sections has accuracy 2.2 ((1/√10))/(1/√(2))) times as high as that of a test pattern including only two measurement sections. Therefore, the priority is set high for the test patterns shown in FIGS. 7A to 7E in which a larger number of measurement sections can be set compared with the test patterns with limited measurement sections such as the test patterns shown in FIGS. 7F and 7G in which specific sections are set as measurement sections and the test patterns shown in FIGS. 7H and 7I having an aspect ratio close to 1. The priority is set higher for the test pattern shown in FIG. 7C than the test pattern shown in FIG. 7A and set higher for the test pattern shown in FIG. 7B than the test pattern shown in FIG. 7C because of the same reason. The priority is set higher for the test pattern shown in FIG. 7G than the test pattern shown in FIG. 7F. The priority is set higher for the test pattern shown in FIG. 7I than the test pattern shown in FIG. 7H.

In a test pattern shown in FIG. 8A, a long line and a short line are arranged vertically and horizontally symmetrically. In the test pattern in which the lines are arranged vertically and horizontally symmetrically, for example, when it is desired to measure line width of the long line in a position where a perpendicular extended from the center of the short line to the long line and the long line cross, it is difficult to specify measurement sections on the resist pattern. On the other hand, in a test pattern shown in FIG. 8B, a long line and two short lines are arranged vertically and horizontally symmetrically. In such a test pattern, when it is desired to measure line width of the long line in a position where a perpendicular extended from the center of the short line to the long line and the long line cross, the line width in the center of the long line only has to be measured. In other words, it is easy to specify measurement sections on the test pattern shown in FIG. 8B than on the test pattern shown in FIG. 8A. As the measurement sections can be specified more easily, measurement of a resist dimension can be performed with higher reproducibility. Therefore, the priority is set higher for the test pattern shown in FIG. 8B than the test pattern shown in FIG. 8A.

In a test pattern shown in FIG. 8C, the line width in an oblique direction is measured. When the length in the oblique direction is measured in this way, it is necessary to measure the length after once rotating an image according to image processing to make it possible to measure the image in the horizontal direction or the vertical direction. However, measurement accuracy is deteriorated because of a rounding error during rotation processing. Therefore, the priority is set low for the test pattern shown in FIG. 8C compared with, for example, a test pattern shown in FIG. 8D in which the length in the horizontal direction is measured and a test pattern in which the length in the vertical direction is measured.

In the above explanation, as an example, measurement accuracy is compared for each of the kinds of the test patterns and the priority is set for the test patterns.

However, the priority is set for each of the test patterns according to measurement accuracy of a resist dimension.

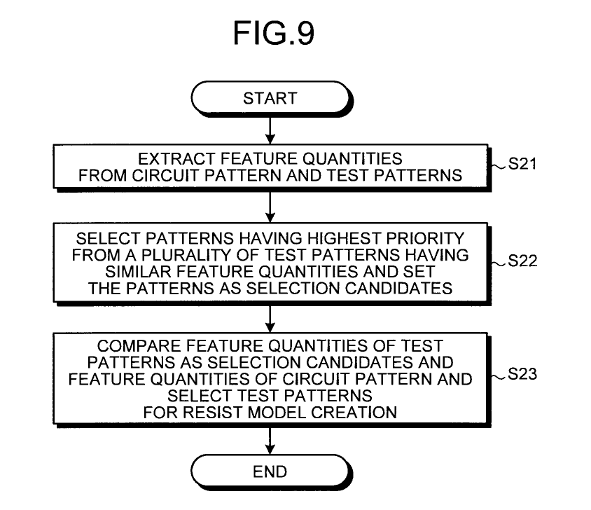

FIG. 9 is a flowchart for explaining the operation of the test-pattern selecting apparatus 20.

First, the feature-quantity extracting apparatus 21 calculates optical images from a mask layout drawing of a large number of test patterns prepared in advance and a circuit pattern and extracts feature quantities from the optical images, respectively (step S21).

Subsequently, the test-pattern selecting unit 23 plots feature quantities of the respective test patterns in a feature space formed by dividing respective coordinate axes with grids at a fixed interval. Then, paying attention to respective small regions divided by the grids, when a plurality of test patterns are plotted in the same small regions, the test-pattern selecting unit 23 executes, for all the small regions, operation for leaving test patterns having a highest priority value and removing the other patterns from the feature space and once sets the test patterns left on the feature space as selection candidates (step S22).

The test-pattern selecting unit 23 plots feature quantities of the circuit pattern in the feature space, compares, for each of the small regions, the feature quantities of the test patterns as the selection candidates and the feature quantities of the circuit pattern, removes the test patterns as the selection candidates from the small regions in which the feature quantities of the circuit pattern are not plotted, and finally selects the remaining test patterns as test patterns for resist model creation (step S23).

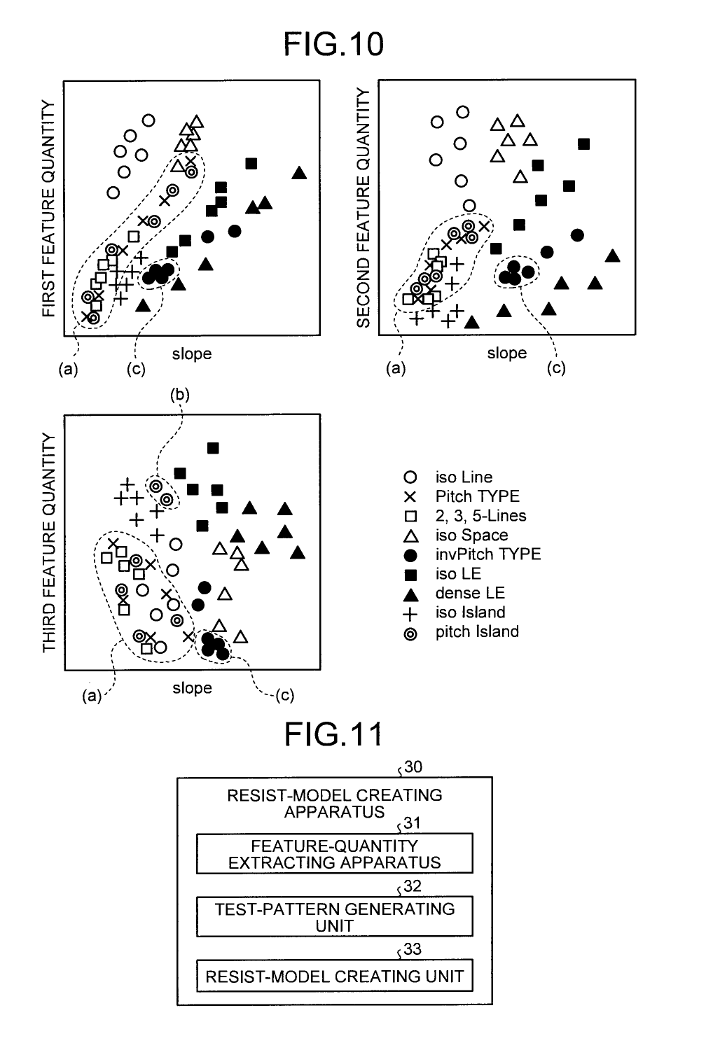

FIG. 10 is a graph in which the first to third feature quantities of the various test patterns shown in FIGS. 7A to 7I are plotted with the abscissa set as slope. Originally, it is appropriate to plot the first to third feature quantities in the feature space, i.e., the space with the first to third feature quantities respectively set as separate coordinate axes. However, to facilitate understanding, the feature quantities are plotted on a graph with the abscissa set as slope. The tendency of selection executed at step S22 is schematically explained with reference to FIG. 10. The test patterns denseLE, isoIsland, isoLine, and isoSpace are relatively less easily removed at step s22 because feature quantities of the test patterns hardly overlap feature quantities of the test patterns of the other types. The test patterns pitchIsland excluding a part thereof indicated (b) in the figure, 2,3,5-Lines, and the Pitch type gather in a range indicated by (a) in the figure. Distribution of feature quantities of the test patterns are similar to one another. Therefore, when the priority is set highest for the Pitch type among pitchIsland, 2,3,5-Lines, and the Pitch type, the test patterns pitchIsland excluding a part thereof and 2,3,5-Lines are removed and the Pitch type is more likely to remain as selection candidates. As the invPitch type, as indicated by (c) in the figure, four feature quantities crowd together. Therefore, four test patterns of the invPitch type is highly likely to be selected based on the level of priority among the test patterns invPitch type. In this way, the test patterns are selected to leave the test patterns that can be measured at as high accuracy as possible.

As explained above, according to the second embodiment, test patterns used for optimization of a resist model are selected based on feature quantities of test patterns and priority set in advance for each of the test patterns according to measurement accuracy for an actual dimension. Therefore, it is possible to create a resist model for which high accuracy is guaranteed using the selected test patterns.

In the above explanation, the test-pattern selecting unit 23 divides respective coordinate axes of a feature space with the grids and selects one test pattern with high priority for each of small regions divided by the grids. However, two or more test patterns can be selected from one small region. Instead of being selected from the small regions divided by the grids, test patterns can be selected by other methods. For example, when the respective coordinate axes of the feature space is normalized and distances among feature quantities of a plurality of test patterns are within a range of a predetermined Euclidian distance in the feature space after the normalization, one test pattern can be selected out of the test patterns based on priority information.

In the above explanation, the test-pattern selecting unit 23 calculates test patterns as selection candidates in advance and finally selects test patterns used for resist model creation out of the test patterns as the selection candidates. However, the test-pattern selecting unit 23 can select test patterns used for resist model creation based on feature quantities of the test patterns, feature quantities of a circuit pattern, and priority information without calculating test patterns as selection candidates in advance.

The test patterns selected according to the second embodiment can be used not only for resist model creation but also as test patterns in creating an etching model.

The second embodiment can be applied when, to predict a pattern formed on a resist, test patterns of a template are selected to cover feature quantities of a circuit pattern of the template.

The test-pattern selecting apparatus 20 according to the second embodiment can be realized by executing a computer program in a usual computer including, for example, the control device 1 such as a CPU, the storage device 2 such as a read only memory (ROM) or a RAM, the external storage device 3 such as a HDD or a CD drive device, the display device 4 such as a display, and the input device 5 such as a keyboard and the mouse shown in FIG. 5.

A test-pattern selecting program executed by the test-pattern selecting apparatus 20 according to the second embodiment can be recorded in a computer-readable recording medium such as a CD-ROM, a flexible disk (FD), a CD-R, or a digital versatile disk (DVD) as a file of an installable format or an executable format and provided.

The test-pattern selecting program executed by the test-pattern selecting apparatus 20 according to the second embodiment can be stored on a computer connected to a network such as the Internet and downloaded through the network to thereby be provided. The test-pattern selecting program executed by the test-pattern selecting apparatus 20 according to the second embodiment can be provided or distributed through the network such as the Internet.

The test-pattern selecting program executed by the test-pattern selecting apparatus 20 according to the second embodiment can be incorporated in the ROM or the like in advance and provided.

The test-pattern selecting program executed by the test-pattern selecting apparatus 20 according to the second embodiment has a module configuration including the respective components (the feature-quantity extracting apparatus 21, the priority-information storing unit 22, and the test-pattern selecting unit 23). As actual hardware, the CPU reads out the test-pattern selecting program from the storage medium and executes the test-pattern selecting program. Consequently, the respective units are loaded onto the main storage device. The feature-quantity extracting apparatus 21, the priority-information storing unit 22, and the test-pattern selecting unit 23 are generated on the main storage device.

A third embodiment of the present invention is explained below. When a dimension (a resist dimension) of a resist pattern formed on a wafer is measured based on test patterns selected for resist model creation for a circuit pattern, in general, a critical dimension-scanning electron microscope (CD-SEM) is used. The CD-SEM is an apparatus manufactured exclusively for a length measuring function among functions such as observation, analysis, and length measurement of a general SEM. However, the CD-SEM cannot obtain a measurement value having high accuracy and reproducibility because of the influence of damage to a measurement pattern due to charge-up and electron beams, roughness of the measurement pattern, or the like.

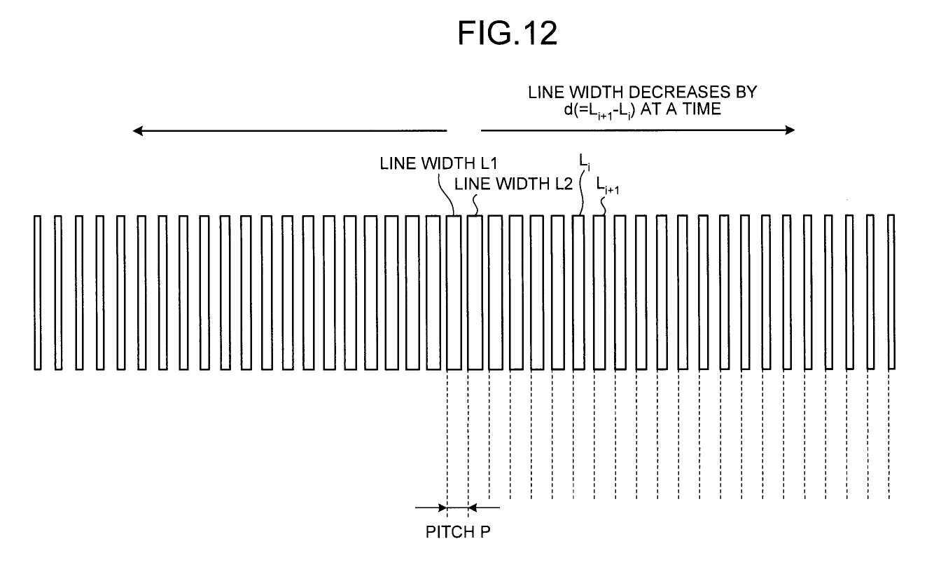

Therefore, in the third embodiment, a resist model is created by using test patterns with which a resist dimension can be measured even if the CD-SEM is not used. FIG. 11 is a block diagram for explaining the configuration of a resist-model creating apparatus according to the third embodiment.

In FIG. 11, a resist-model creating apparatus 30 includes a feature-quantity extracting apparatus 31 that calculates optical images from a mask layout drawing of a circuit pattern and extracts feature quantities from the calculated optical images, a test-pattern generating unit 32 that generates a mask layout drawing of test patterns to cover a distribution of feature quantities of the circuit pattern extracted by the feature-quantity extracting apparatus 31, and a resist-model creating unit 33 that creates a resist model by optimizing various calibration parameters of the resist model based on the mask layout drawing of the test patterns generated by the test-pattern generating unit 32. The feature-quantity extracting apparatus 31 can be the same as the feature-quantity extracting apparatus 10 explained in the first embodiment.

The mask layout drawing of the test patterns generated by the test-pattern generating unit 32 is explained below. FIG. 12 is a diagram for explaining an example of a layout on a mask of the test patterns. As shown in the figure, the mask layout of the test patterns generated by the test-pattern generating unit 32 has a line and space (L/S) structure in which lines and spaces are alternately arranged at a repetition period (pitch) P. The line width of a line in the center of the line and space is L₀. The line width of the respective lines gradually decreases from the pattern center to ends such that a difference between line widths (Lᵢ, Lᵢ₊₁) of adjacent lines is a fixed value d (=Lᵢ₊₁−Lᵢ). The respective lines are light transmitting units that transmit exposure light. P satisfies the following condition:

P<λ/{NA(1+σ)} Formula 4

where, λ, Na, and σ are the wavelength of an exposure apparatus, the number of lens apertures, and a coherence factor of illumination, respectively.

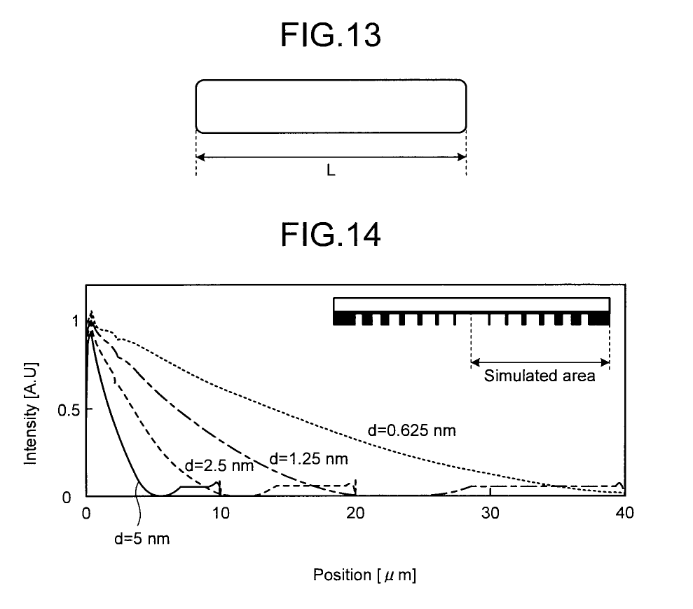

When the condition of Formula 4 is satisfied, the L/S structure on the mask is not resolved on the wafer and, instead, a bar-like resist pattern is formed as shown in FIG. 13. Length L in a longitudinal direction of the bar-like resist pattern changes according to values of a line width change amount d and center line width L₀ in the mask layout of the test patterns. FIG. 14 is a graph on which image intensity in a longitudinal direction of a bar-like optical image calculated by simulation from the mask layout of the test patterns is plotted. Exposure conditions are exposure wavelength of 248 nanometers (KrF) and 0.68 NA/0.75λσ. Test patterns used in the simulation have a pitch P of 190 nanometers and four kinds of line width change amounts d of 0.625 nanometer, 1.25 nanometers, 2.5 nanometers, and 5 nanometers. As shown in the figure, as a value of the line width change amount d decreases, the gradient of image intensity of a bar-like optical image projected on a resist becomes gentler and the foot of the graph widens. Therefore, it is seen that the length L in the longitudinal direction of the resist pattern increases.

The size of the test patterns on the mask and values of the line width change amount d, the center line width L₀, and the pitch P are set such that the length L in the longitudinal direction of the resist pattern is length (e.g., several microns) that can be measured by an optical measuring apparatus (e.g., a stereo microscope). When the length L is measured by the optical measuring apparatus, since there is no charge-up or damage to a measuring object, high measurement reproducibility can be obtained. With the test patterns shown in FIG. 12, because the L/S structure is not resolved on the wafer, the test patterns are less easily affected by a focus during exposure. In general patterns, because a dimension may deviate because of the influence of defocus, it is likely that a correct resist model cannot be created because of unintended dimension fluctuation. With the test patterns shown in FIG. 12, a finish of the resist pattern on the wafer does not change even if the optical measuring apparatus is defocused. Therefore, creation of a resist model that cannot be correctly predicted is not caused by process fluctuation that causes defocus.

In this way, the shape of the optical image can be freely changed by changing the values of the line width change amount d, the center line width L₀, and the pitch P using the mask layout drawing of the test patterns shown in FIG. 12. Therefore, values of feature quantities can be changed according to the change in the optical image. Irrespectively of what type of feature quantity distribution a circuit pattern has, the test-pattern generating unit 32 adjusts the value of the line width change amount d, the center line width L₀, or the pitch P and generates test patterns corresponding to the feature quantity distribution of the circuit pattern.

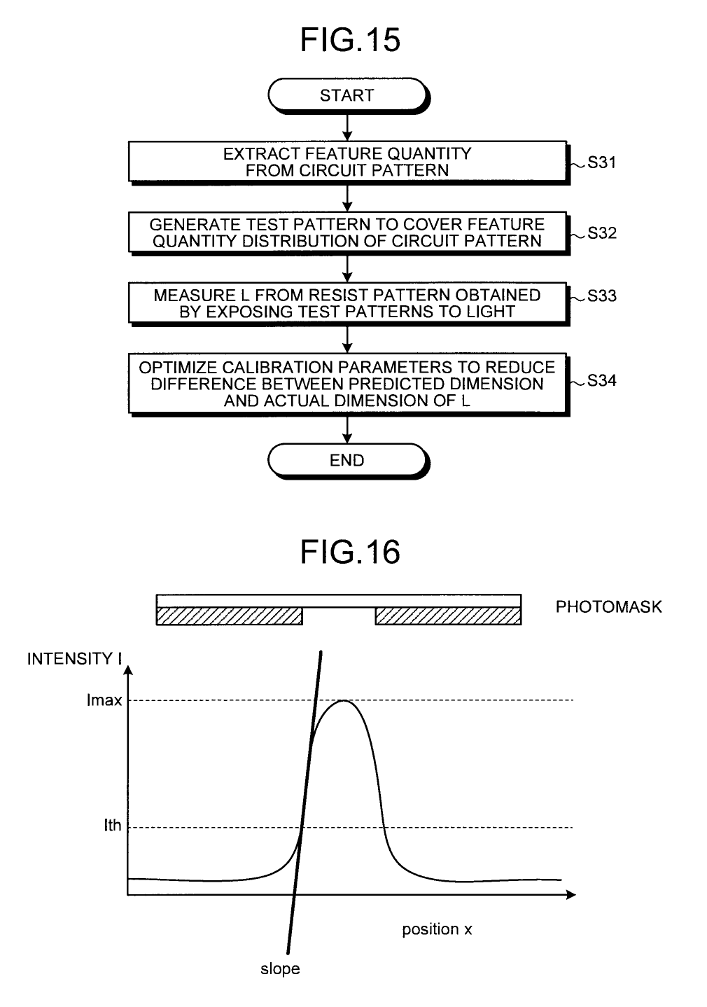

FIG. 15 is a flowchart for explaining the operation of the resist-model creating apparatus 30 according to the third embodiment.

In FIG. 15, first, the feature-quantity extracting apparatus 31 calculates an optical image from a circuit pattern and extracts feature quantities from the calculated optical image (step S31). The test-pattern generating unit 32 adjusts values of the line width change amount d, the center line width L₀, and the pitch P to cover a distribution of the extracted feature quantities and generates a plurality of different test patterns (step S32). The value of the pitch P is adjusted in a range in which Formula 4 is satisfied, i.e., a range in which the L/S structure cannot be resolved on the wafer.

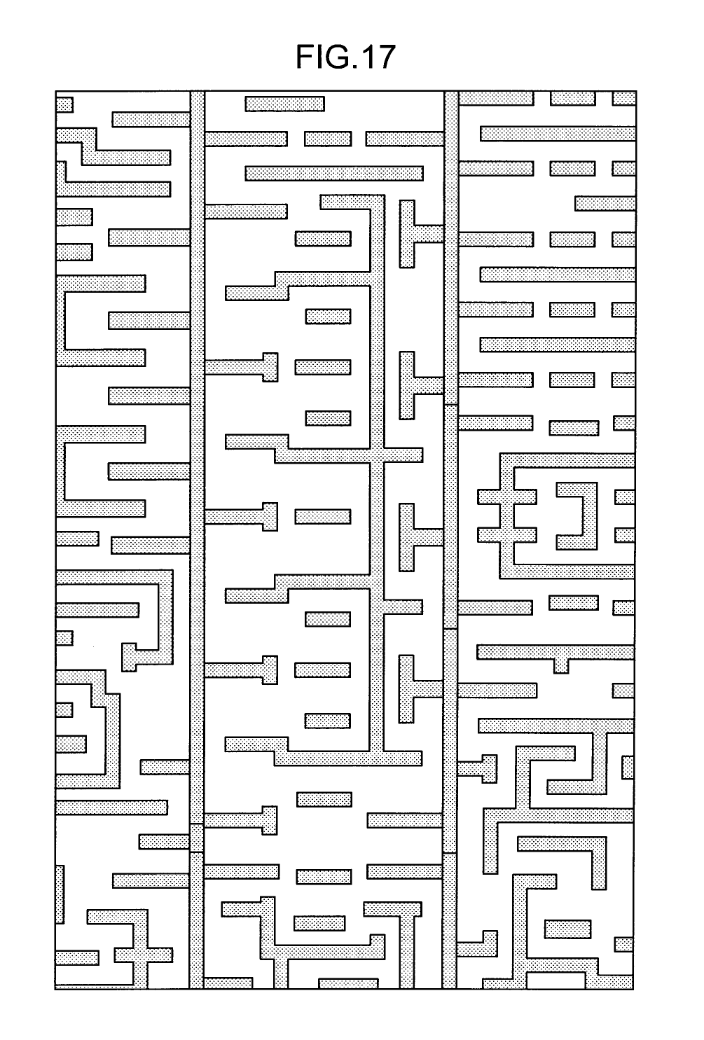

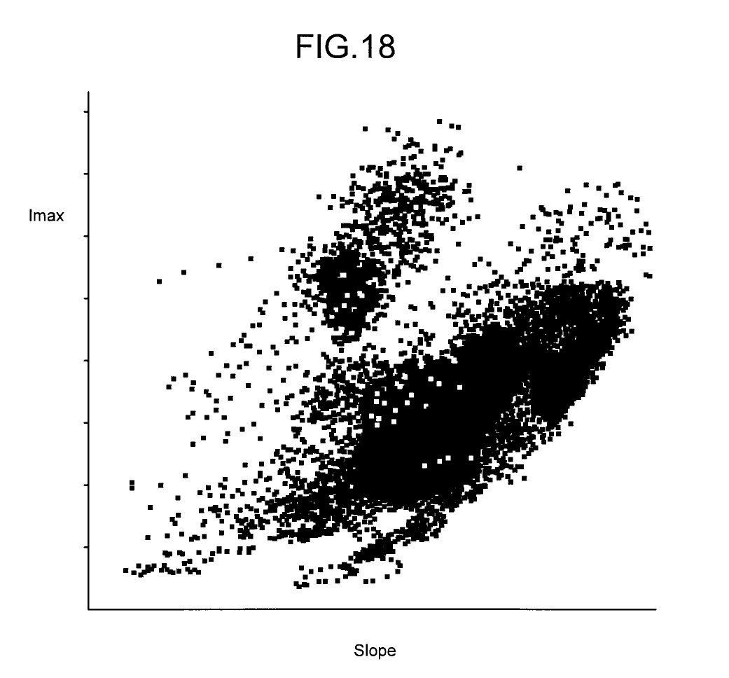

For example, it is assumed that the feature-quantity extracting apparatus 31 defines, as feature quantities, a maximum Imax of intensity of the optical image and a tilt slope of optical image intensity at an edge. FIG. 16 is a diagram for explaining Imax and slope. Slope is a tile of image intensity at an edge (a section where the optical image is sliced at a predetermined threshold Ith) and Imax is a maximum of the image intensity. It is assumed that, at step S31, the feature-quantity extracting apparatus 31 calculates an optical image from a circuit pattern shown in FIG. 17, extracts Imax and slope from the calculated optical image, and obtains a feature quantity distribution shown in FIG. 18.

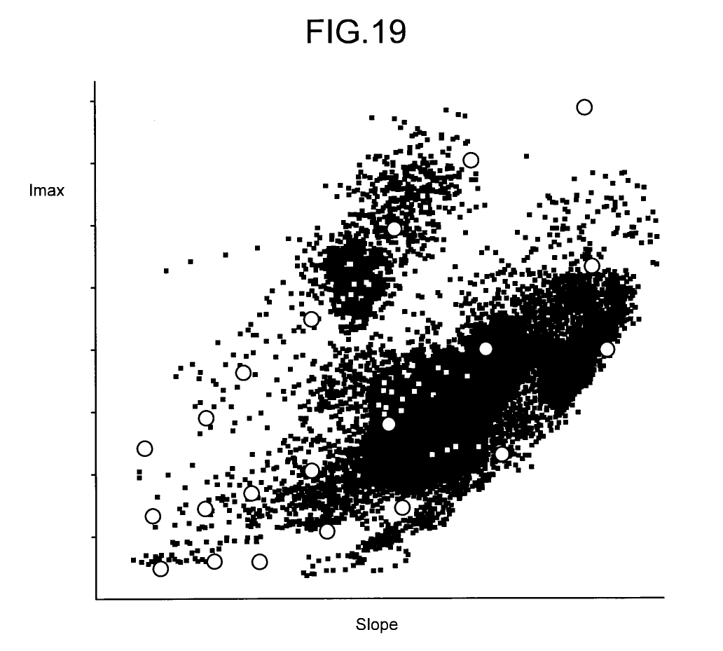

Imax is larger as L₀ is larger. Slope is larger as d is larger. At step S32, the test-pattern generating unit 32 mainly adjusts L₀ and d to thereby generate test patterns having feature quantities located at white circles shown in FIG. 19 with respect to the distribution of the circuit pattern shown in FIG. 18.

Referring back to FIG. 15, the test-pattern generating unit 32 exposes the test patterns created at step S32 and measures L from resist from resist patterns of the test patterns with an optical misalignment inspection device that uses a stereo microscope or visible light as a light source (step S33). The resist-model creating unit 33 optimizes calibration parameters of a simulation model to reduce a difference between a predicted dimension of L for the test patterns and an actual dimension of L measured at step S33 (step S34).

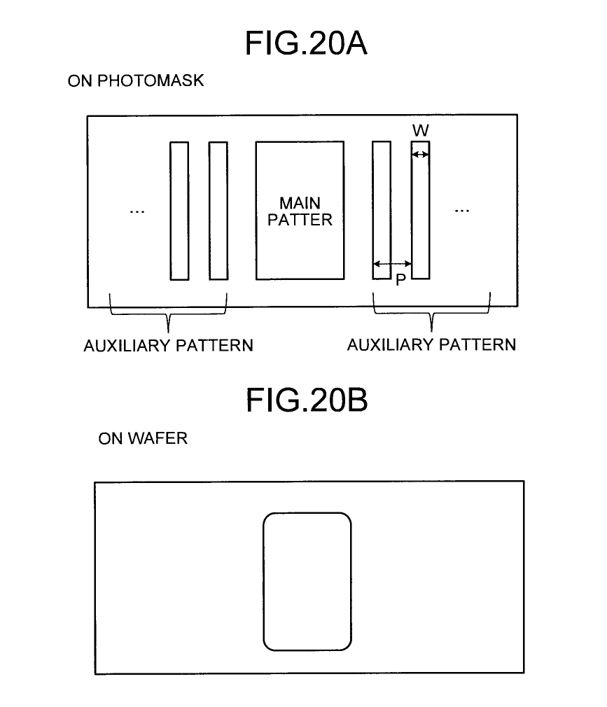

The test pattern of the line and space shown in FIG. 12 is explained as an example of a test pattern generated by the test-pattern generating unit 32. However, test patterns including a main pattern having size that can be resolved on a wafer and auxiliary patterns not resolved on the wafer can be generated. FIG. 20B is an example of a resist image of the test patterns shown in FIG. 20A formed on the wafer. An image intensity distribution of the resist image can be changed by controlling line width W, a pitch P, the number N, and the shape of the auxiliary patterns of the test patterns. Feature quantities can be changed according to the change. Therefore, at step S32, the test-pattern generating unit 32 can generate the test patterns shown in FIG. 20A with the line width W, the pitch P, the number N, and the shape of the auxiliary patterns adjusted to cover a feature quantity distribution of the circuit pattern.

As explained above, according to the third embodiment, test patterns of lines and spaces with dimensions of the lines and the spaces adjusted in a range in which the test patterns are not resolved on a wafer are generated. A resist model is created based on a residual between a predicted dimension of the generated test patterns and an actual dimension of a resist pattern formed on the wafer. Therefore, a resist pattern not depending on process fluctuation is transferred on to the wafer. A dimension of the resist pattern can be measured by the optical measuring apparatus instead of the CD-SEM. In other words, an actual dimension having high reproducibility and high accuracy can be obtained. Therefore, it is possible to create a resist model with high accuracy guaranteed.

The resist-model creating apparatus 30 according to the third embodiment can be realized by executing a computer program in a usual computer including, for example, the control device 1 such as a CPU, the storage device 2 such as a read only memory (ROM) or a RAM, the external storage device 3 such as a HDD or a CD drive device, the display device 4 such as a display, and the input device 5 such as a keyboard and the mouse shown in FIG. 5.

A resist-model creating program executed by the resist-model creating apparatus 30 according to the third embodiment can be recorded in a computer-readable recording medium such as a CD-ROM, a flexible disk (FD), a CD-R, or a digital versatile disk (DVD) as a file of an installable format or an executable format and provided.

The resist-model creating program executed by the resist-model creating apparatus 30 according to the third embodiment can be stored on a computer connected to a network such as the Internet and downloaded through the network to thereby be provided. The resist-model creating program executed by the resist-model creating apparatus 30 according to the third embodiment can be provided or distributed through the network such as the Internet.

The resist-model creating program executed by the resist-model creating apparatus 30 according to the third embodiment can be incorporated in the ROM or the like in advance and provided.

The resist-model creating program executed by the resist-model creating apparatus 30 according to the third embodiment has a module configuration including the respective components (the feature-quantity extracting apparatus 31, the test-pattern generating unit 32, and the resist-model creating unit 33). As actual hardware, the CPU reads out the resist-model creating program from the storage medium and executes the resist-model creating program. Consequently, the respective units are loaded onto the main storage device. The feature-quantity extracting apparatus 31, the test-pattern generating unit 32, and the resist-model creating unit 33 are generated on the main storage device.

A fourth embodiment of the present invention is explained below. With the CTM in the past, a resist image is described by a linear model with feature quantities set as explanatory variables. Therefore, to create a highly accurate resist model, it is desirable that a relation between values of various feature quantities and a difference (a residual) between an actual dimension and a predicted dimension has a linear relation in which a determination coefficient is as close as possible to 1.

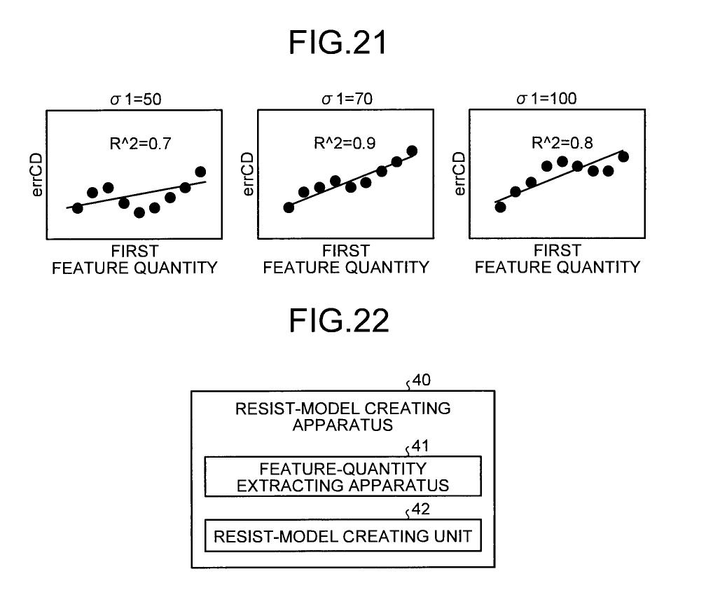

On the other hand, in the CTM, feature quantities are extracted according to a nonlinear function using feature-quantity extraction parameters. FIG. 21 is a graph of a relation between first feature quantities at σ1 of 50, 70, and 100 and a residual (errCD). In the case of σ1=70, a determination coefficient (R2) is closest to 1. In other cases, the determination coefficient is small compared with that in the case of σ1=70. In other words, the determination coefficient of the relation between the various feature quantities and the residual changes according to a value of σ1.

Therefore, when the calibration parameters are optimized (step S4 in FIG. 1), in the past, the calibration parameters are optimized by the method of causing, while optimizing various feature-quantity extraction parameters with, for example, a simplex method such that a relation between various feature quantities and a residual has a linear relation in which a determination coefficient is as close as possible to 1, a relation between a resist image and the various feature quantities to linearly regress and returning the residual to the simplex method as a cost function in respective times of iteration.

However, with this method, feature quantities are extracted every time the feature-quantity extraction parameters are changed. Therefore, large calculation cost is necessary and calculation load and resist model creation time are extremely large.

According to the fourth embodiment, a relation between a resist image and various feature quantities is caused to nonlinearly regress, whereby a highly accurate resist model is quickly created without varying the feature-quantity extraction parameters. FIG. 22 is a block diagram for explaining the configuration of the resist-model creating apparatus according to the fourth embodiment.

As shown in the figure, a resist-model creating apparatus 40 includes a feature-quantity extracting apparatus 41 that calculates optical images from a mask layout drawing of test patterns selected for resist model creation and extracts feature quantities from the calculated optical images and a resist-model creating unit 42 that optimizes calibration parameters for a resist model based on the feature quantities extracted by the feature-quantity extracting apparatus 41 and an actual dimension of the selected test patterns.

The feature-quantity extracting apparatus 41 can be any apparatus as long as the apparatus can extract the first to third feature quantities and can be the same as, for example, the feature-quantity extracting apparatus explained in the first embodiment. The test patterns for resist model creation can be test patterns selected by any method and can be test patterns selected by, for example, the method explained in the second embodiment.

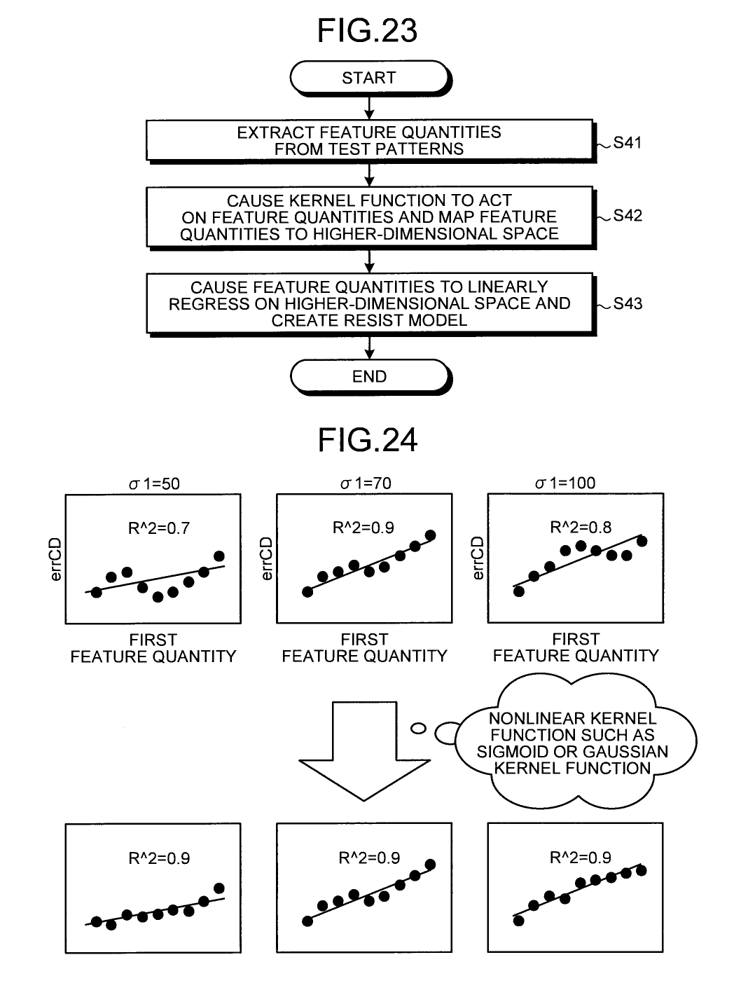

FIG. 23 is a flowchart for explaining the operation of the resist-model creating apparatus 40 according to the fourth embodiment.

In FIG. 23, first, the feature-quantity extracting apparatus 41 executes simulation, which is based on optical calculation, on a mask layout drawing of test patterns to calculate optical images and extracts the first to third feature quantities from the calculated optical images (step S41). Arbitrary values can be used as feature-quantity extraction parameters.

Subsequently, the resist-model creating unit 42 causes a nonlinear kernel function to act on feature quantities of the respective test patterns, i.e., the first feature quantity, the second feature quantity, and the third feature quantity and maps the feature quantities of the respective test patterns to a higher-dimensional space (step S42). As the nonlinear kernel function, there are a Gaussian kernel, a sigmoid kernel, a logistic kernel, and the like. The resist-model creating unit 42 selects and uses an appropriate kernel function such that the feature quantities can be caused to linearly regress in the higher-dimensional space at the mapping destination.

The resist-model creating unit 42 causes the respective feature quantities to linearly regress in the higher-dimensional space and creates a resist model such that a residual among the test patterns is minimized (step S43). As a method of causing the feature quantities to linearly regress, methods of highly accurately causing the feature quantities to linearly regress using a support vector machine and a neural network are known. The resist-model creating unit 42 performs linear regression of the feature quantities using these methods.

FIG. 24 is a conceptual diagram for explaining a state in which a relation between the first feature quantity and the residual is caused to linearly regress on the higher-dimensional space. Three figures in the upper part of FIG. 24 are the same as the three figures of FIG. 21. When the kernel function is caused to act on the three figures in the upper part, the three figures in the upper part can be converted to have a linear relation in which a determination function is closer to 1 in a space at a mapping destination as shown in three figures in the lower part. In other words, irrespectively of what kind of value σ1 is, the feature quantities can be caused to linearly regress with the determination coefficient close to 1 in the space at the mapping destination. The three figures in the lower part represent the higher-dimensional space after the conversion. Therefore, because the abscissa and the ordinate do not have physical meaning, the abscissa and the ordinate are not shown.

As explained above, after being mapped to the higher-dimensional space by the nonlinear kernel function, the respective feature quantities are caused to linearly regress in the space. This is like the feature quantities being caused to nonlinearly regress in a space before the mapping. In other words, according to the fourth embodiment, a resist image is described in a nonlinear model with feature quantities set as explanatory variables. Therefore, it is possible to omit the process of optimizing feature-quantity extraction parameters in the past.

Optical images were calculated under lithography conditions for using zone illumination with NA1.0/σ0.95/ε0.75. Seventy-five kinds of feature quantities were respectively calculated by using the following seventy-five kinds of combinations of feature-quantity extraction parameters in total:

σ1=20, 30, 40 nm

(σ2, b0)=(100, 0.1), (150, 0.1), (200, 0.1), (100, 0.15), (150, 0.15)

(σ3, b1)=(100, 0.1), (150, 0.1), (200, 0.1), (100, 0.15), (150, 0.15)

Differences between predicted dimensions and actual dimensions of resist images calculated by (1) the linear model and (2) the nonlinear model (the method according to the fourth embodiment) were compared.

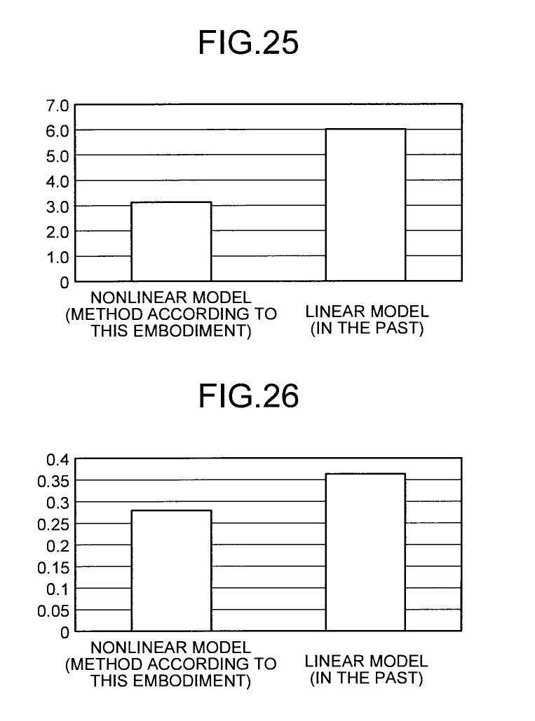

FIG. 25 is a graph of a comparison result. A residual root mean square (RMS) is used as a residual. As shown in the figure, it is seen that the residual RMS is smaller in the nonlinear model according to this embodiment than the linear model in the past. This means that, although it was necessary to optimize σ1, σ2, σ3, b0, and b1 to minimize the residual, feature-quantity extraction parameters with which accuracy obtained in the nonlinear model could be attained could not be selected because only the seventy-five kinds of feature quantities were tested this time. However, according to this embodiment, a relation between feature quantities and a residual does not always need to be linear and an obtained nonlinear model has high accuracy compared with the linear model.

FIG. 26 is a graph of fluctuation of residual RMSs. Residual RMSs are calculated based on seventy-five kinds of feature-quantity extraction parameters and standard deviations of the residuals RMSs are compared. In the linear model, the residual RMSs substantially fluctuate when the feature-quantity extraction parameters are changed. With the nonlinear model according to the fourth embodiment, fluctuation in the residual RMSs is smaller than the fluctuation in the residual RMSs in the linear model. Therefore, it is seen that, with the nonlinear model according to the fourth embodiment, it is unnecessary to optimize the feature-quantity extraction parameters.

With the linear model in the past, when five parameters are optimized by the simplex method, four hundred seventy times of iteration are required. If more than seventy-five kinds of feature-quantity extraction parameters are used to create a resist model with a smaller residual RMS, a larger number of times of iteration are required according to an increase of parameters. Therefore, larger calculation cost and calculation time are necessary and time necessary for resist model creation increases. On the other hand, according to the fourth embodiment, an accurate resist model can be created by one calculation using one kind of feature-quantity extraction parameters. Therefore, it is possible to substantially reduce calculation time.

As explained above, according to the fourth embodiment, the nonlinear function is caused to act on feature quantities of optical images of test patterns to map the feature quantities to a higher-dimensional space and, based on a residual between a predicted dimension of a resist image of the test patterns and an actual dimension of a resist pattern formed on a wafer, a relation between the resist image of the test patterns and the feature quantities are caused to linearly regress on the higher-dimensional space to create a resist model. Therefore, it is possible to quickly create a highly accurate resist model without varying the feature-quantity extraction parameters.

In the above explanation, feature quantities are extracted from optical images of test patterns by using feature-quantity extraction parameters and a resist model for predicting a resist image is created by using the extracted feature quantities as explanatory variables. However, the fourth embodiment can be applied to any method of extracting feature quantities from a first pattern using feature-quantity extraction functions for which feature-quantity extraction parameters are set and creating a simulation model for predicting a second pattern using the extracted feature quantities as explanatory variables. For example, the technology of the fourth embodiment can be applied to a method of extracting feature quantities from a layout drawing of mask patterns, optical images, or a resist image (a first pattern) using feature-quantity extraction functions for which feature-quantity extraction parameters are set and creating an etching model for predicting a pattern (a second pattern), which is formed on a processed layer by etching, using the extracted feature quantities as explanatory variables. Further, in nano-imprinting for forming a pattern on a processed layer using a template, the technology of the fourth embodiment can be applied to a method of extracting feature quantities from a pattern (a first pattern) of the template using feature-quantity extraction functions for which feature-quantity extraction parameters are set and creating a simulation model for predicting a pattern (a second pattern) formed on the processed layer using the extracted feature quantities as explanatory variables.

The resist-model creating apparatus 40 according to the fourth embodiment can be realized by executing a computer program in a usual computer including, for example, the control device 1 such as a CPU, the storage device 2 such as a read only memory (ROM) or a RAM, the external storage device 3 such as a HDD or a CD drive device, the display device 4 such as a display, and the input device 5 such as a keyboard and the mouse shown in FIG. 5.

A resist-model creating program executed by the resist-model creating apparatus 40 according to the fourth embodiment can be recorded in a computer-readable recording medium such as a CD-ROM, a flexible disk (FD), a CD-R, or a digital versatile disk (DVD) as a file of an installable format or an executable format and provided.

The resist-model creating program executed by the resist-model creating apparatus 40 according to the fourth embodiment can be stored on a computer connected to a network such as the Internet and downloaded through the network to thereby be provided. The resist-model creating program executed by the resist-model creating apparatus 40 according to the fourth embodiment can be provided or distributed through the network such as the Internet.

The resist-model creating program executed by the resist-model creating apparatus 40 according to the fourth embodiment can be incorporated in the ROM or the like in advance and provided.

The resist-model creating program executed by the resist-model creating apparatus 40 according to the fourth embodiment has a module configuration including the respective components (the feature-quantity extracting apparatus 41 and the resist-model creating unit 42). As actual hardware, the CPU reads out the resist-model creating program from the storage medium and executes the resist-model creating program. Consequently, the respective units are loaded onto the main storage device. The feature-quantity extracting apparatus 41 and the resist-model creating unit 42 are generated on the main storage device.

A fifth embodiment of the present invention is explained below. In general, a designer designs a circuit pattern based on design rules. Up to a 130 nm node, the design rules are decided with lithography taken into account. If the designer designs a layout based on the design rules, the circuit pattern can be patterned and produced without a problem with the lithography. However, in a 90 nm node or beyond, simple design rules are insufficient and more complicated design rules are required. However, if design rules are too complicated, it is difficult to even present the design rules.

Therefore, as described in the document “Proc. SPIE Vol. 5130 (2003) p. 628”, in circuit pattern design, lithography verification for design data for performing lithography simulation and verifying whether a problem occurs in production in view of the likelihood of a lithography process is performed.

Concerning a created resist model, effectiveness of predicted values by the resist model is guaranteed when feature quantities of a circuit model is within a range covered by a feature quantity distribution of test patterns used in resist model creation. If the designer designs a circuit pattern deviating from the range of the feature quantity distribution, a resist image corresponding to the circuit pattern cannot be accurately predicted. In the past, the lithography verification is performed irrespectively of whether feature quantities of a circuit pattern are within a range of a feature quantity distribution of test patterns. Therefore, it is likely that the lithography verification is performed based on invalid predicted values.

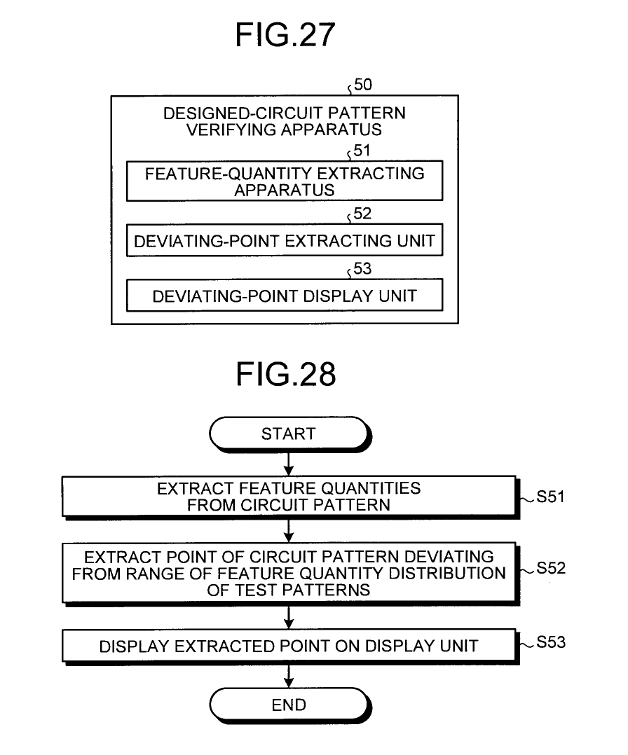

In the fifth embodiment, a section where effectiveness of predicted values is not guaranteed in a designed circuit pattern is deduced by determining whether the designed circuit pattern deviates from a distribution range of a feature quantity distribution of test patterns. FIG. 27 is a block diagram for explaining the configuration of a designed-circuit-pattern verifying apparatus according to the fifth embodiment.

As shown in FIG. 27, the designed-circuit-pattern verifying apparatus 50 includes a feature-quantity extracting apparatus 51 that extracts feature quantities from a plurality of points in a mask layout drawing of a circuit pattern designed by a designer, a deviating-point extracting unit 52 that compares a distribution of the extracted feature quantities of the circuit pattern and a distribution of feature quantities of test patterns used in resist model creation to thereby extract a point of the circuit pattern deviating from a range covered by the distribution of the feature quantities of the test patterns, and a deviating-point display unit 53 that displays the extracted point on the circuit pattern on a display unit. The feature-quantity extracting apparatus 51 can be the same as the feature-quantity extracting apparatus used in the first embodiment.

FIG. 28 is a flowchart for explaining the operation of the designed-circuit pattern verifying apparatus 50.

In FIG. 28, first, the feature-quantity extracting apparatus 51 calculates optical images from a mask layout drawing of a circuit pattern designed by the designer and extracts feature quantities from the calculated optical images (step S51). The deviating-point extracting unit 52 compares, based on the feature quantities extracted from the circuit pattern, a distribution of the feature quantities of the circuit pattern and a distribution of feature quantities of test patterns used for resist model creation and extracts a point of the circuit pattern deviating from a range in which the feature quantities deviate from a range covered by the distribution of the feature quantities of the test patterns (step S52).

It is desirable to determine, for example, as explained below, whether the feature quantities of the circuit pattern deviate from the range covered by the distribution of the feature quantities of the test patterns. Specifically, it is desirable to normalize a feature space, plot the feature quantities of the circuit pattern and the test patterns in the normalized feature space, and determine that points corresponding to dots of the circuit pattern do not deviate when dots of at least one test pattern are present within a predetermined Euclidian distance from dots of the circuit pattern and that the points deviate when no dot of the test patterns is present within the predetermined Euclidian distance. The predetermined Euclidian distance is desirably set to, for example, 0.1.

It is also possible to give scores corresponding to Euclidian distances to dots of the respective test patterns to dots corresponding to respective points of the circuit pattern in the normalized feature space and determine that points of the circuit pattern with the scores equal to or smaller than a fixed value deviate and points of the circuit pattern with the scores exceeding the fixed value deviate. It is desirable to calculate score values by, for example, integrating, in all the test patterns, values calculated by causing a Gaussian function or the like to act on distances to the dots of the test patterns.

It is also possible to divide respective coordinate axes in a feature space with grids at a fixed interval and, paying attention to small regions of a minimum unit divided by the grids, determine that a circuit pattern does not deviate when feature quantities of test patterns are plotted in a small region same as a small region in which feature quantities of points of the circuit pattern are plotted and that the circuit pattern deviates when the feature quantities of the test patterns are not plotted in the small region.

Following step S52, the deviating-point display unit 53 displays the extracted point of the circuit pattern on a display device such as a liquid crystal display (step S53). Effectiveness of predicted values by a resist model is not guaranteed in the point displayed on the display device. Therefore, the designer desirably changes a shape of the displayed point to a shape with which effectiveness of predicted values is guaranteed.

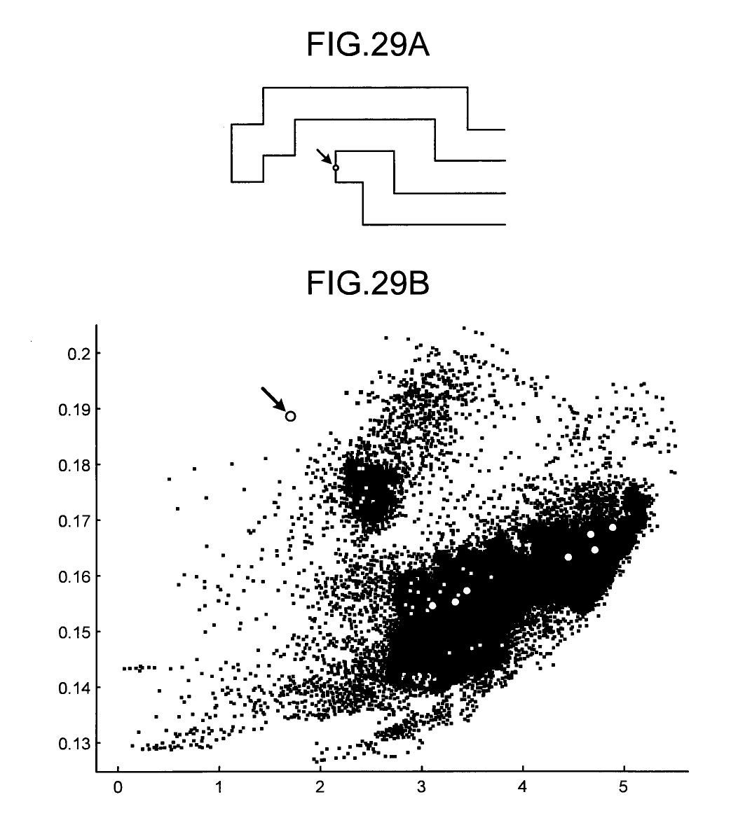

FIG. 29A is a diagram of a designed circuit pattern. FIG. 29B is a graph with the abscissa representing a slope and the ordinate representing a first feature quantity on which a distribution of feature quantities of the circuit pattern (white circles) are plotted together with a distribution of feature quantities of test patterns. A feature quantity of a point indicated by an arrow in FIG. 29A deviates from the distribution of the feature quantities of the test patterns like a dot indicated by an arrow in FIG. 29B. At step S52, the deviating-point extracting unit 52 extracts a point indicated by the arrow in FIG. 29A. At step S53, the deviating-point display unit 53 clearly displays the point on the display device as shown in FIG. 29A.

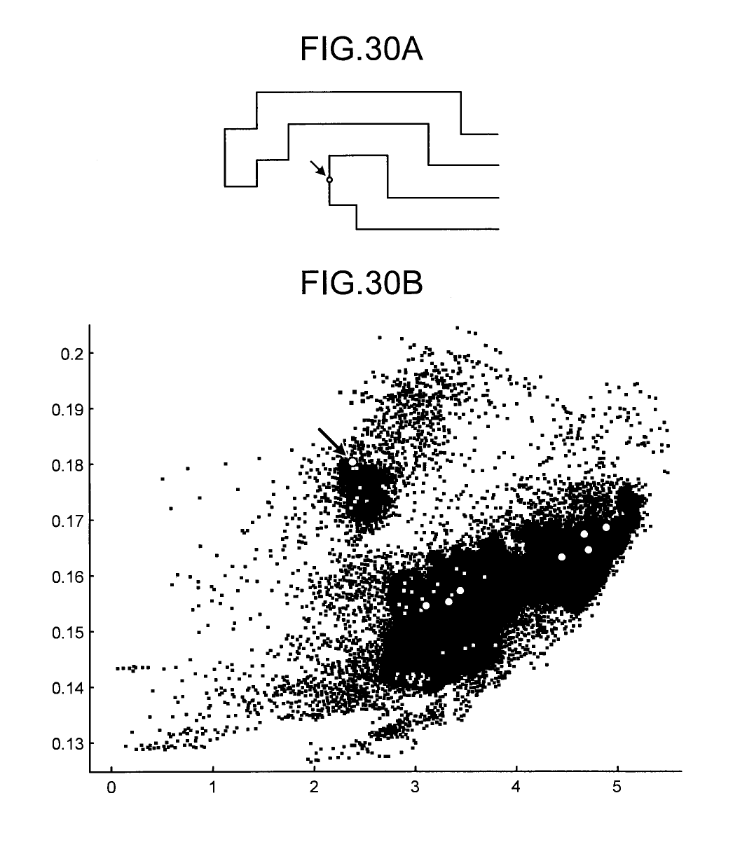

When the designer learns that the point deviates from the distribution of the feature quantities of the test patterns, the designer corrects the mask layout drawing of the circuit pattern, for example, as shown in FIG. 30A. The operation of the designed-circuit-pattern verifying apparatus 50 is executed on the circuit pattern after the correction. If a feature quantity of a point indicated by an arrow in FIG. 30A does not deviate from the distribution of the feature quantities of the test patterns like a dot indicated by an arrow in FIG. 30B, the corrected point is not displayed on the display device this time. Therefore, the designer can learn that the point can be corrected to a design with effectiveness of a predicted value guaranteed.

As explained above, according to the fifth embodiment, a distribution of feature quantities of a circuit pattern created by the designer and a distribution of feature quantities of test patterns are compared, a point of the circuit pattern deviating from a range of the feature quantity distribution of the test patterns is calculated, and the calculated point is displayed. Therefore, the designer can learn a section where prediction accuracy for predicted values by a resist model is not guaranteed. Consequently, the designer can correct a mask layout drawing of the circuit pattern to a shape with which the prediction accuracy can be guaranteed.

In the above explanation, verification of a circuit pattern is performed by using a resist model for predicting a resist image using feature quantities extracted from optical images of test patterns as explanatory variables. However, the fifth embodiment can be applied in any case as long as verification of a design drawing of a first pattern or a design drawing of another pattern for creating the first pattern is performed by using a simulation model for predicting a second pattern using feature quantities extracted from the first pattern as explanatory variables. For example, the fifth embodiment can be applied when verification of a design drawing of a mask pattern is performed by using an etching model for predicting a pattern (a second pattern) formed on a processed layer by etching using feature quantities extracted from a layout drawing of the mask pattern, optical images, or a resist image (a first pattern) as explanatory variables. Further, in nano-imprinting for forming a pattern on a processed layer using a template, the fifth embodiment can be applied when verification of a design drawing of a pattern of a template is performed by using a simulation model for predicting a pattern (a second pattern) formed in a processed layer using feature quantities extracted from a pattern (a first pattern) of the template as explanatory variables.

The designed-circuit-pattern verifying apparatus 50 according to the fifth embodiment can be realized by executing a computer program in a usual computer including, for example, the control device 1 such as a CPU, the storage device 2 such as a read only memory (ROM) or a RAM, the external storage device 3 such as a HDD or a CD drive device, the display device 4 such as a display, and the input device 5 such as a keyboard and the mouse shown in FIG. 5.

A designed-circuit-pattern verifying program executed by the designed-circuit-pattern verifying apparatus 50 according to the fifth embodiment can be recorded in a computer-readable recording medium such as a CD-ROM, a flexible disk (FD), a CD-R, or a digital versatile disk (DVD) as a file of an installable format or an executable format and provided.

The designed-circuit-pattern verifying program executed by the designed-circuit-pattern verifying apparatus 50 according to the fifth embodiment can be stored on a computer connected to a network such as the Internet and downloaded through the network to thereby be provided. The designed-circuit-pattern verifying program executed by the designed-circuit-pattern verifying apparatus 50 according to the fifth embodiment can be provided or distributed through the network such as the Internet.

The designed-circuit-pattern verifying program executed by the designed-circuit-pattern verifying apparatus 50 according to the fifth embodiment can be incorporated in the ROM or the like in advance and provided.

The designed-circuit-pattern verifying program executed by the designed-circuit-pattern verifying apparatus 50 according to the fifth embodiment has a module configuration including the respective components (the feature-quantity extracting apparatus 51, the deviating-point extracting unit 52, and the deviating-point display unit 53). As actual hardware, the CPU reads out the designed-circuit-pattern verifying program from the storage medium and executes the designed-circuit-pattern verifying program. Consequently, the respective units are loaded onto the main storage device. The feature-quantity extracting apparatus 51, the deviating-point extracting unit 52, and the deviating-point display unit 53 are generated on the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A feature-quantity extracting method comprising:
setting feature-quantity extraction parameters used by feature-quantity extraction functions for calculating feature quantities used as explanatory variables of a resist model for predicting a resist image; and
causing the feature-quantity extraction functions, for which the feature-quantity extraction parameters are set, to act on optical images of a pattern of a photomask and calculating feature quantities from the optical images.

2. The feature-quantity extracting method according to claim 1, wherein the setting further includes:
acquiring one or more feature-quantity extraction parameters of a resist model used in a past;
calculating a range in which the acquired feature-quantity extraction parameters are fit; and
setting feature-quantity extraction parameter used by the feature-quantity extraction functions from the calculated range.

3. The feature-quantity extracting method according to claim 1, wherein the resist model is a constant threshold model (CTM).

4. The feature-quantity extracting method according to claim 1, wherein
the pattern of the photomask is test patterns prepared in advance including test patterns used for measuring a residual between a predicted dimension of the resist image by the resist model and an actual dimension of a resist pattern formed on a wafer, and
the feature-quantity extracting method further comprises selecting, based on feature quantities calculated from respective optical images of the test patterns prepared in advance and priority set in advance for each of the test patterns according to measurement accuracy of the actual dimension, a test pattern used for measuring the residual out of the test patterns prepared in advance.

5. The feature-quantity extracting method according to claim 4, wherein the priority is set in advance according to measurement accuracy of a resist dimension.

6. The feature-quantity extracting method according to claim 1, wherein
the pattern of the photomask is a circuit pattern, and
the feature-quantity extracting method further comprises:
generating, according to a distribution of the feature quantities calculated from the optical images of the circuit pattern, test patterns which have lines and spaces adjusted in a range in which dimensions of lines and spaces are not resolved on a wafer; and
creating a resist model based on a residual between a predicted dimension of a resist image of the generated test patterns and an actual dimension of a resist pattern formed on a wafer.

7. The feature-quantity extracting method according to claim 6, wherein line width of the respective lines included in the test patterns decreases toward at least one direction among lining-up directions of the lines of the line and space.

8. The feature-quantity extracting method according to claim 6, wherein the range in which the dimensions of the lines and the spaces are not resolved on the wafer is a range in which a relation among a pitch P of the test patterns, wavelength 2 of an exposure apparatus, a number of lens apertures Na, and a coherence factor σ of illumination satisfies a condition P<λ/{NA(1+σ)}.

9. The feature-quantity extracting method according to claim 8, wherein the actual dimension of the resist pattern formed on the wafer is measured by an optical measuring device.

10. The feature-quantity extracting method according to claim 4, further comprising causing a nonlinear function to act on the feature quantities calculated from the optical images of the selected respective test patterns to map the feature quantities to a higher-dimensional space and causing, based on a residual between a predicted dimension of a resist image of the test patterns and an actual dimension of a resist pattern formed on a wafer, a relation between the resist image of the test patterns and the feature quantities to linearly regress in the higher-dimensional space to create a resist model.

11. The feature-quantity extracting method according to claim 10, wherein the nonlinear function is a kernel function including a Gaussian kernel, a sigmoid kernel or a logistic kernel.

12. The feature-quantity extracting method according to claim 11, wherein the linear regression is liner regression performed by using a support vector machine or a neural network.

13. A designed-circuit pattern verifying method comprising:
setting feature-quantity extraction parameters used by feature-quantity extraction functions for calculating feature quantities used as explanatory variables of a resist model for predicting a resist image;
causing the feature-quantity extraction functions, for which the feature-quantity extraction parameters are set, to act on optical images of a circuit pattern created by a designer and calculating feature quantities at a plurality of points of the circuit pattern from the optical images;
comparing a distribution of the calculated feature quantities and a distribution of feature quantities of test patterns and extracting a point of the circuit pattern deviating from a range of the feature quantity distribution of the test patterns; and
displaying the extracted point of the circuit pattern on a display device.

14. The designed-circuit-pattern verifying method according to claim 13, wherein the extracting includes determining, based on a Euclidian distance between the calculated feature quantities of the circuit pattern and the feature quantities forming the feature quantity distribution of the test patterns, whether points where the feature quantities of the circuit pattern are calculated deviate from a range of the feature quantity distribution of the test pattern.

15. The designed-circuit-pattern verifying method according to claim 14, wherein the determining further includes:
calculating, according to the Euclidian distance, a score for each of the points where the feature quantities of the circuit pattern are calculated; and
determining, based on the calculated score, whether the points where the feature quantities of the circuit pattern are calculated deviate from the range of the feature quantity distribution of the test patterns.

16. A computer program product executable by a computer, the computer program product causing the computer to execute:
setting feature-quantity extraction parameters used by feature-quantity extraction functions for calculating feature quantities used as explanatory variables of a resist model for predicting a resist image; and
causing the feature-quantity extraction functions, for which the feature-quantity extraction parameters are set, to act on optical images of a pattern of a photomask and calculating feature quantities from the optical images.

17. The computer program product according to claim 16, wherein the setting further includes;
acquiring one or more feature-quantity extraction parameters of a resist model used in a past;
calculating a range in which the acquired feature-quantity extraction parameters are fit; and
setting feature-quantity extraction parameter used by the feature-quantity extraction functions from the calculated range.

18. The computer program product according to claim 16, wherein the resist model is a constant threshold model (CTM).
